(19) United States
(12) Patent Application Publication
(10) Pub. No.: US 2026/0361205 A1
(43) Pub. Date: Nov. 12, 2026

(54) GENERAL STARTUP FOR MULTI-LEVEL POWER CONVERTER CIRCUITS

(71) Applicant: pSemi Corporation, San Diego, CA (US)

(72) Inventor: Gregory Szczeszynski, Nashua, NH (US)

(21) Appl. No.: 19/735,415

(22) Filed: Jul. 8, 2026

Related U.S. Application Data
(63) Continuation of application No. PCT/US2025/011261, filed on Jan. 10, 2025.
(60) Provisional application No. 63/620,465, filed on Jan. 12, 2024.
(60) Provisional application No. 63/620,607, filed on Jan. 12, 2024.
(60) Provisional application No. 63/620,638, filed on Jan. 12, 2024.

(51) Int. Cl. H02M 1/00; H02M 3/158

(52) U.S. Cl. CPC H02M 1/009; H02M 3/158

(57) ABSTRACT

Circuits and methods are provided that more effectively and efficiently implement multi-level converter circuits. Power switch circuitry may be implemented to selectively route a first voltage between a first terminal and a second terminal. The first terminal may be electrically couplable to a supply voltage and the second terminal may be electrically couplable to a load, such as a battery. The integrated circuit further includes control circuitry configurable to generate a second voltage from the first voltage by selectively operating the power switch circuitry to charge and/or discharge one or more capacitors. A startup sequence may include charging a high-side voltage with a battery, pre-charging one or more fly capacitors and boot capacitors using the battery, operating in a 2-level mode, and transitioning to one or more multi-level modes.

### CROSS-REFERENCE TO RELATED APPLICATIONS

This patent application is a continuation of International Patent Application No. PCT/US2025/011261 filed Jan. 10, 2025 and entitled “GENERAL STARTUP FOR MULTI-LEVEL POWER CONVERTER CIRCUITS,” which claims the benefit of and priority to U.S. Provisional Patent Application No. 63/620,465 filed Jan. 12, 2024 and entitled “STARTUP INTERLOCK FOR POWER CONVERTER CIRCUITS,” U.S. Provisional Patent Application No. 63/620,607 filed Jan. 12, 2024 and entitled “STARTUP VOLTAGE SELECTION FOR MULTI-LEVEL POWER CONVERTER CIRCUITS,” and U.S. Provisional Patent Application No. 63/620,638 filed Jan. 12, 2024 and entitled “GENERAL STARTUP FOR MULTI-LEVEL POWER CONVERTER CIRCUITS,” which are incorporated herein by reference in their entirety.

This patent application and International Patent Application No. PCT/US2025/011261 filed Jan. 10, 2025 and entitled “GENERAL STARTUP FOR MULTI-LEVEL POWER CONVERTER CIRCUITS” are related to the following United States Provisional patent applications filed on Jan. 12, 2024, which are all incorporated herein by reference in their entirety:
Application No. 63/620,507 entitled “LEVEL SHIFTER AND BOOT CAPACITOR CIRCUITS, SYSTEMS, AND METHODS;”
Application No. 63/620,623 entitled “LEVEL SHIFTER AND BOOT CAPACITOR CIRCUITS, SYSTEMS, AND METHODS;”
Application No. 63/620,613 entitled “INTEGRATED CURRENT RESISTOR SENSING FOR MULTI-LEVEL CONVERTER;”
Application No. 63/620,465 entitled “STARTUP INTERLOCK FOR POWER CONVERTER CIRCUITS;”
Application No. 63/620,331 entitled “FULLY DIFFERENTIAL LEVEL SHIFT IN A NOISY ENVIRONMENT;”
Application No. 63/620,450 entitled “CAPACITOR SENSING AND CAPACITOR BALANCING SYSTEMS AND METHODS;”
Application No. 63/620,469 entitled “CAPACITOR SENSING AND CAPACITOR BALANCING SYSTEMS AND METHODS;”
Application No. 63/620,678 entitled “RECONFIGURABLE MULTI-LEVEL POWER CONVERTER TO CHARGE PUMP MODE AND FRACTIONAL CHARGE PUMP MODE;”
Application No. 63/620,417 entitled “INPUT CURRENT SLEW FOR A MULTI-LEVEL CONVERTER;”
Application No. 63/620,726 entitled “ADJUSTING OVERVOLTAGE PROTECTION BASED ON MODE OF OPERATION SYSTEMS AND METHODS;”
Application No. 63/620,737 entitled “HYBRID PEAK AVERAGE CURRENT MODE CONTROL;”
Application No. 63/620,741 entitled “CURRENT LIMITED VOLTAGE MODE CONTROL OF MULTIPLE INPUTS;”
Application No. 63/620,527 entitled “MULTI-FUNCTION COMP PIN SYSTEMS AND METHODS;”
Application No. 63/620,488 entitled “LEVEL SHIFTER AND BOOT CAPACITOR CIRCUITS, SYSTEMS, AND METHODS;”
Application No. 63/620,553 entitled “MULTI-LEVEL REVERSE CURRENT BLOCKING SYSTEMS AND METHODS;”
Application No. 63/620,638 entitled “GENERAL STARTUP FOR MULTI-LEVEL POWER CONVERTER CIRCUITS;”
Application No. 63/620,733 entitled “PRECISION ANALOG TO DIGITAL CIRCUIT TUNED VOLTAGE AND CURRENT MODE DC-DC CONVERTER;”
Application No. 63/620,738 entitled “PREDICTIVE CONTROL LOOP PRE-CHARGING DURING A MULTI-LEVEL ZONE CHANGE;”
Application No. 63/620,764 entitled “DETECTOR CIRCUIT FOR DETECTING ONE OF MULTI-INPUT CONTROLLING SIGNALS THAT CONTROLS A CONTROL LOOP CIRCUIT;”
Application No. 63/620,607 entitled “STARTUP VOLTAGE SELECTION FOR MULTI-LEVEL POWER CONVERTER CIRCUITS;”
Application No. 63/620,575 entitled “MULTI-LEVEL CAPACITOR FAULT DETECTION SYSTEMS AND METHODS;”
Application No. 63/620,582 entitled “PARALLEL OPERATION OF MULTI-LEVEL POWER CONVERTERS;” and
Application No. 63/620,763 entitled “AVERAGE AND PEAK CURRENT SENSE SYSTEMS AND METHODS.”

### BACKGROUND

This disclosure relates to electronic circuits, and more particularly for example to multi-level power converters.

Many electronic products, including mobile computing and/or communication products and components (e.g., notebook computers, ultra-book computers, tablet devices, LCD, LED displays, and the like) use multiple voltage levels for operation. For example, radio frequency (RF) transmitter power amplifiers may operate at relatively high voltages (e.g., 12V or more), whereas logic circuitry may operate at a relatively low voltage level (e.g., 1-3V) and other circuitry may operate at an intermediate voltage level (e.g., 5-10V).

Direct current power converters are often used to generate a lower or higher voltage from a common power source, such as a battery, solar cells, and rectified AC sources. Power converters which generate a lower output voltage level from a higher input voltage power source are commonly known as buck converters, so-called because the output voltage V_{OUT} is less than the input voltage V_{IN}, and hence the converter is “bucking” the input voltage. Power converters which generate a higher output voltage level from a lower input voltage power source are commonly known as boost converters, because V_{OUT} is greater than V_{IN}. Some power converters may be either a buck converter or a boost converter depending on which terminals are used for input and output. Some power converters may provide an inverted output.

One type of direct current power converter known as a multi-level power converter includes charge transfer capacitors as energy storage elements coupled by controlled switches to transfer charge from V_{IN} to V_{OUT}. Such charge transfer capacitors are commonly known as “fly capacitors” or “pump capacitors”. When a fly capacitor is used (i.e., not bypassed), the electrical energy flowing through that fly capacitor generally will either charge it or discharge it.

There is a continued need for improved circuits and methods for more effectively and efficiently operating and implementing various type of electrical circuits and devices, including for example multi-level converter circuits.

### SUMMARY

Embodiments of the present disclosure include systems, circuits, and methods for operating and implementing various electronics circuits, including multi-level converter circuits.

In some embodiments, a system includes power switch circuitry having a plurality of switches configurable to route a voltage between a first terminal and a second terminal, with the second terminal being electrically couplable to receive a first voltage from a load (e.g., a battery). The system further includes control circuitry configurable to control the power switch circuitry to selectively charge and/or discharge one or more fly capacitors to generate a boosted voltage at the first terminal from the first voltage received at the second terminal, and a first electrical path configurable to electrically couple the first terminal and the first voltage. The plurality of switches include a first switch and a first gate driver for operating the first switch, the first gate driver electrically couplable to the first voltage through a second electrical path.

The control circuitry is configurable to operate a startup sequence that includes applying the first voltage to the first terminal via the first electrical path, pre-charging, by selectively controlling the power switch circuitry, a first fly capacitor of the one or more fly capacitors using the first voltage received at the second terminal, and pre-charging the first gate driver using the first voltage via the second electrical path. The startup sequence may further include, after the control circuitry pre-charges the first gate driver, operating the control circuitry as a two-level multi-level power converter.

The startup sequence may further include sequentially transitioning two-level multi-level power converter operation to an M-level power converter operation, where M≥3, where each transition from a current level, N, to a next level, N+1, includes pre-charging an N+1-level fly capacitor of the one or more fly capacitors, pre-charging, for each N+1-level switch, the corresponding gate driver, and transitioning to N+1-level boost converter operation when one or more pre-charging thresholds are exceeded.

The first switch may be implemented as a field effect transistor that forms a body diode configurable to facilitate current flow through the first switch when the first switch is in an OFF state. The first electrical path may include a resistor and a diode (e.g., a Schottky diode) connected in series.

In various embodiments, a method includes initiating, using control circuitry, a startup sequence for circuitry comprising power switch circuitry configurable to route a voltage between a first terminal and a second terminal, wherein the second terminal is electrically couplable to receive a first voltage from a load. The method may further include applying, via a first electrical path electrically coupling the first terminal and the first voltage, the first voltage to the first terminal. The method may further include pre-charging a first fly capacitor of the one or more fly capacitors using the first voltage received at the second terminal, and pre-charging a first gate driver corresponding to a first switch of the plurality of switches through a second electrical path configurable to electrically couple the first voltage and the first gate driver, wherein the first gate driver controls operation of the first switch.

In various embodiments, a system includes a multi-level power converter including a plurality of switches and a corresponding plurality of boot capacitors, each of the plurality of boot capacitors configurable to provide a control signal to the corresponding switch, and control circuitry configurable to control the plurality of switches to selectively charge and discharge one or more fly capacitors using a first voltage received at a second terminal to generate a boosted voltage at a first terminal.

The multi-level power converter may be configurable to operate a startup sequence including applying the first voltage to the first terminal on a first electrical path, pre-charging a first fly capacitor of the one or more fly capacitors using the first voltage to a level exceeding a pre-charging threshold based on a ratio of the boosted voltage, and pre-charging a first boot capacitor corresponding to a first switch using the first voltage.

The scope of the present disclosure is defined by the claims, which are incorporated into this section by reference. A more complete understanding of embodiments of the present disclosure will be afforded to those skilled in the art, as well as a realization of additional advantages thereof, by a consideration of the following detailed description of one or more embodiments. Reference will be made to the appended sheets of drawings that will first be described briefly.

### DESCRIPTION OF THE DRAWINGS

FIG. 1A is an example power converter circuit with internal input current sense, in accordance with one or more embodiments of the present disclosure.

FIG. 1B is an example power converter circuit with external input current sense, in accordance with one or more embodiments of the present disclosure.

FIG. 2A is an example dual integrated circuit (IC) power converter circuit with internal input current sense, in accordance with one or more embodiments of the present disclosure.

FIG. 2B is an example dual IC power converter circuit with external input current sense, in accordance with one or more embodiments of the present disclosure.

FIG. 3A is an example functional block diagram of a power converter circuit, in accordance with one or more embodiments of the present disclosure.

FIG. 3B is an example functional block diagram of a power converter circuit, in accordance with one or more embodiments of the present disclosure.

FIG. 4 is a diagram illustrating an example charging function in step down regulation mode of an example power converter circuit, in accordance with one or more embodiments of the present disclosure.

FIG. 5 is a diagram illustrating an example charging function in step down divide by 3 charge pump mode, in accordance with one or more embodiments of the present disclosure.

FIG. 6 is a functional block diagram illustrating aspects of an example power converter circuit, in accordance with one or more embodiments of the present disclosure.

FIG. 7 is a block diagram illustrating an example system implementing a power converter circuit, in accordance with one or more embodiments of the present disclosure.

FIG. 8A is a circuit diagram illustrating an example 3-level converter circuit, in accordance with one or more embodiments of the present disclosure.

FIG. 8B is a circuit diagram illustrating an example 4-level converter circuit, in accordance with one or more embodiments of the present disclosure.

FIG. 8C is a circuit diagram illustrating an example M-level converter circuit, in accordance with one or more embodiments of the present disclosure.

FIG. 9 is an example M-level converter circuit, in accordance with one or more embodiments of the present disclosure.

FIG. 10 is a block diagram of an example embodiment of control circuitry for an M-level converter cell, in accordance with one or more embodiments of the present disclosure.

FIG. 11 is a high-level block diagram illustrating inrush and/or backflow mitigation circuitry, in accordance with one or more embodiments of the present disclosure.

FIG. 12 is block diagram illustrating example power switching circuitry and an example interlock circuit, in accordance with one or more embodiments of the present disclosure.

FIG. 13 is a functional block diagram illustrating example logic for operating an interlock circuit, in accordance with one or more embodiments of the present disclosure.

FIG. 14 illustrates an example startup sequence for a power converter, including operation of a disconnect switch to mitigate inrush and/or backflow, in accordance with one or more embodiments of the present disclosure.

FIG. 15 is a high-level block diagram illustrating example inrush and/or backflow mitigation circuitry, in accordance with one or more embodiments of the present disclosure.

FIG. 16 is a high-level block diagram of a system including a multi-level power converter circuit, in accordance with one or more embodiments of the present disclosure.

FIG. 17 illustrates example circuitry used for starting a multi-level power converter, in accordance with one or more embodiments of the present disclosure.

FIG. 18, illustrates an example startup process for a multi-level power converter using the circuitry of FIG. 17, in accordance with one or more embodiments of the present disclosure.

FIG. 19 illustrates operational voltage levels of an example 4-level multi-level power converter, in accordance with one or more embodiments of the present disclosure.

FIG. 20 illustrates example circuitry for optimizing startup voltage of a multi-level power converter, in accordance with one or more embodiments of the present disclosure.

FIG. 21 illustrates an example startup process including optimization of startup voltage for a multi-level power converter, in accordance with one or more embodiments of the present disclosure.

Embodiments of the present disclosure and their advantages are best understood by referring to the detailed description that follows. It is noted that sizes of various components and distances between these components are not drawn to scale in the FIGURES. It should be appreciated that like reference numerals are used to identify like elements illustrated in one or more of the FIGURES.

### DETAILED DESCRIPTION

The present disclosure encompasses novel circuits, architectures, systems, and methods that more effectively and efficiently address the configuration and operation of multi-level converter circuits. It will be appreciated that various improvements disclosed herein encompass innovative circuits, hardware components, architectures, and related logic that are applicable to applications beyond multi-level converter circuits.

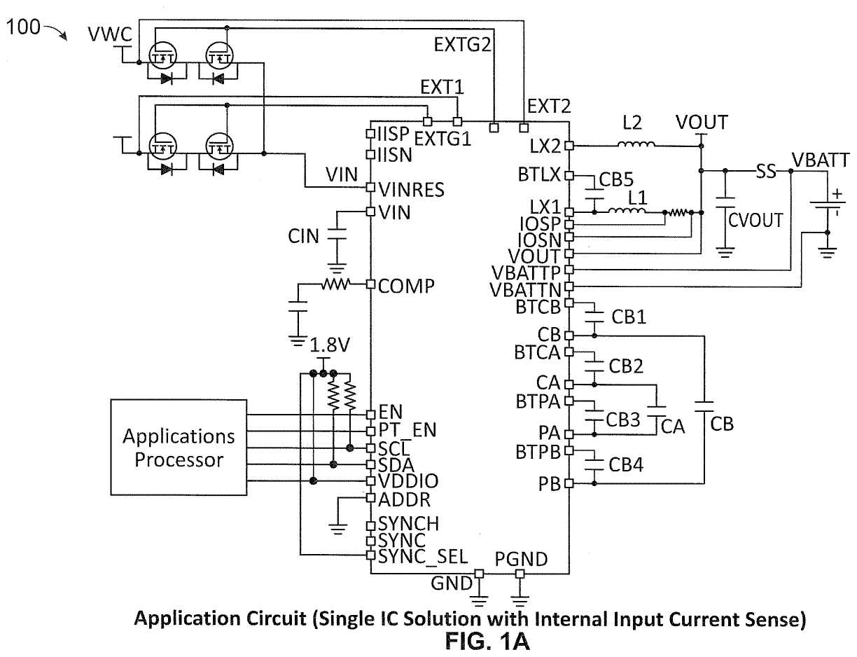

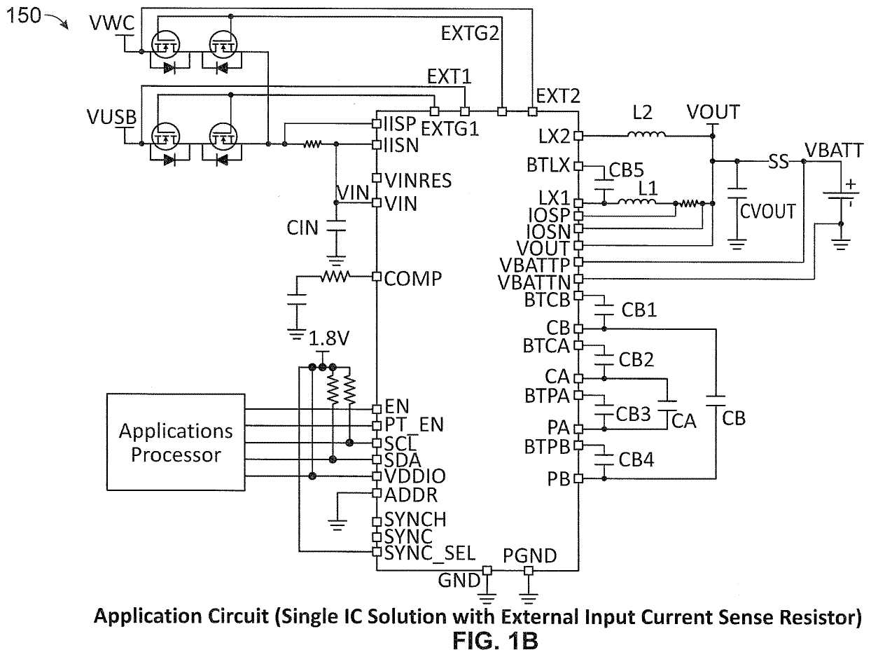

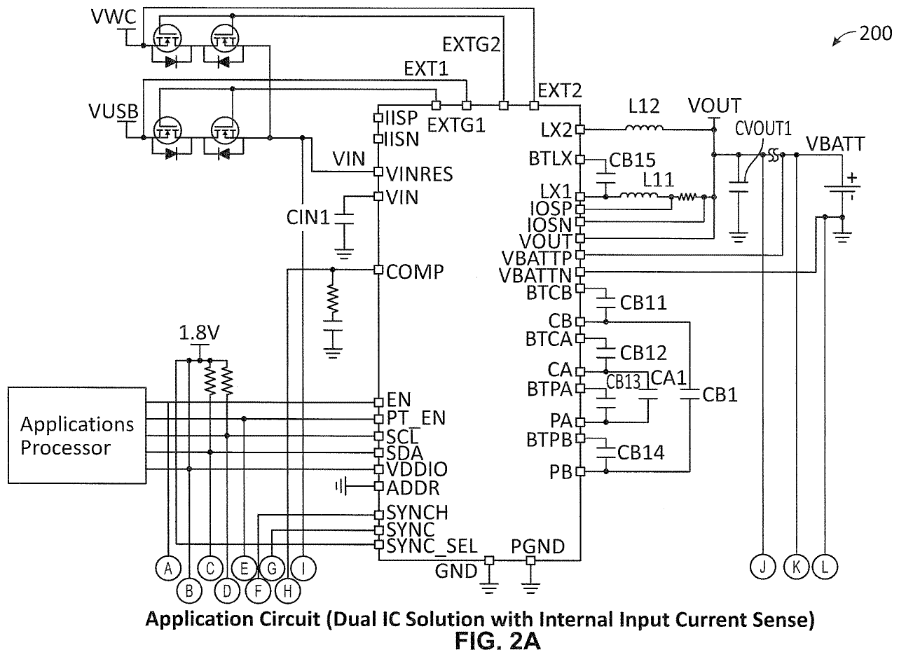

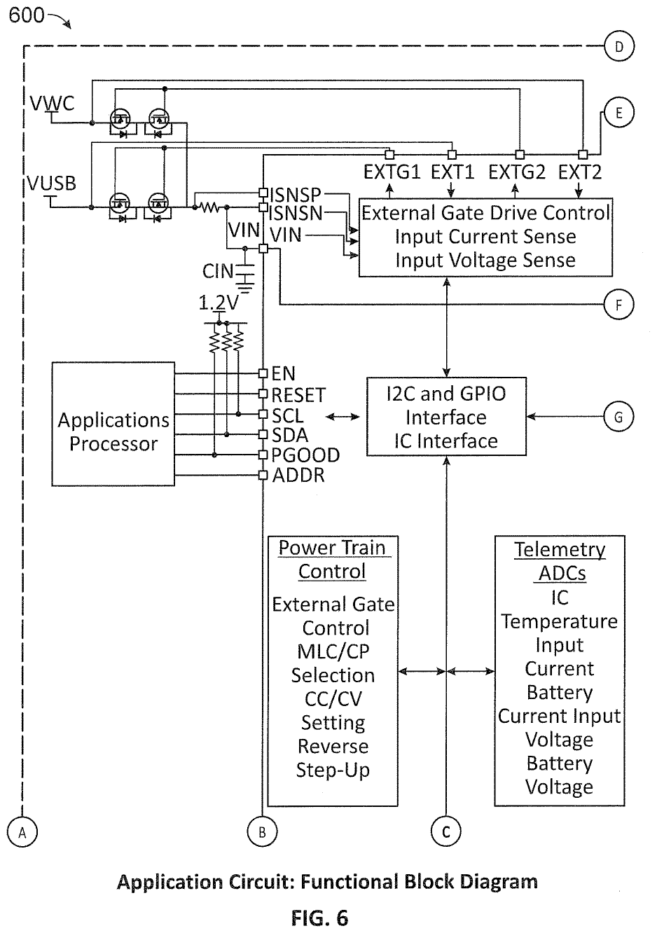

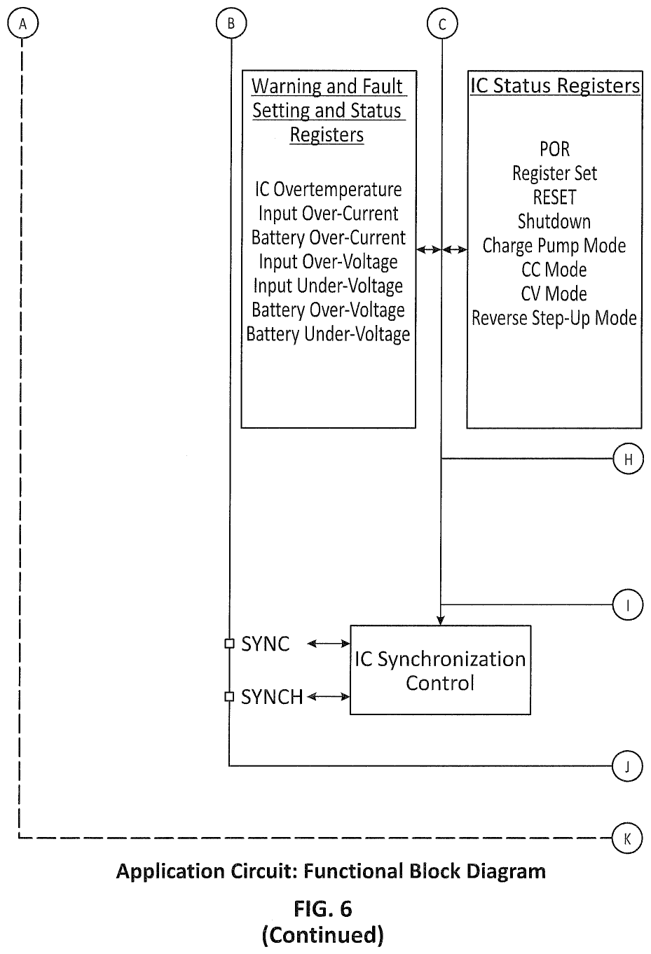

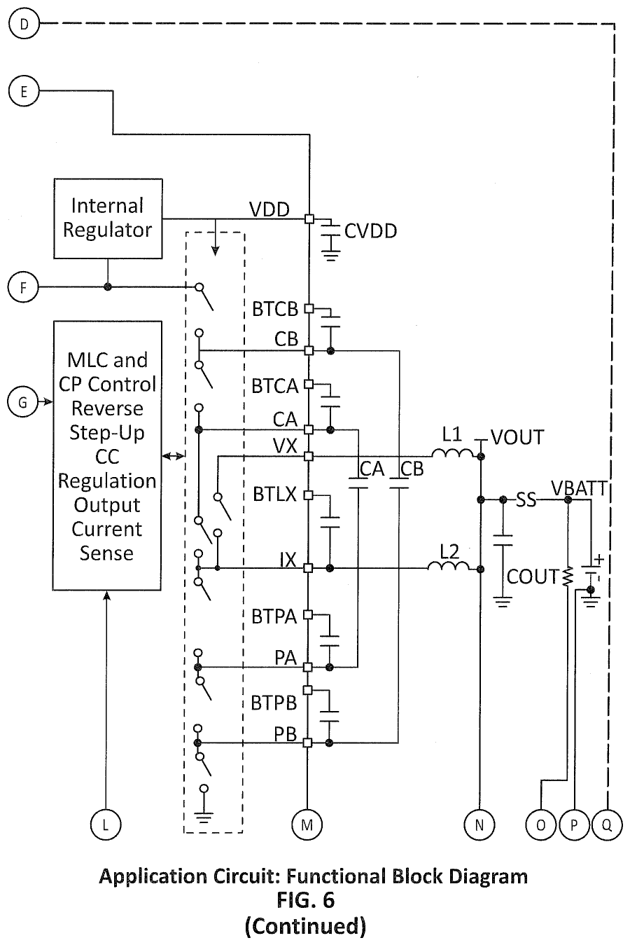

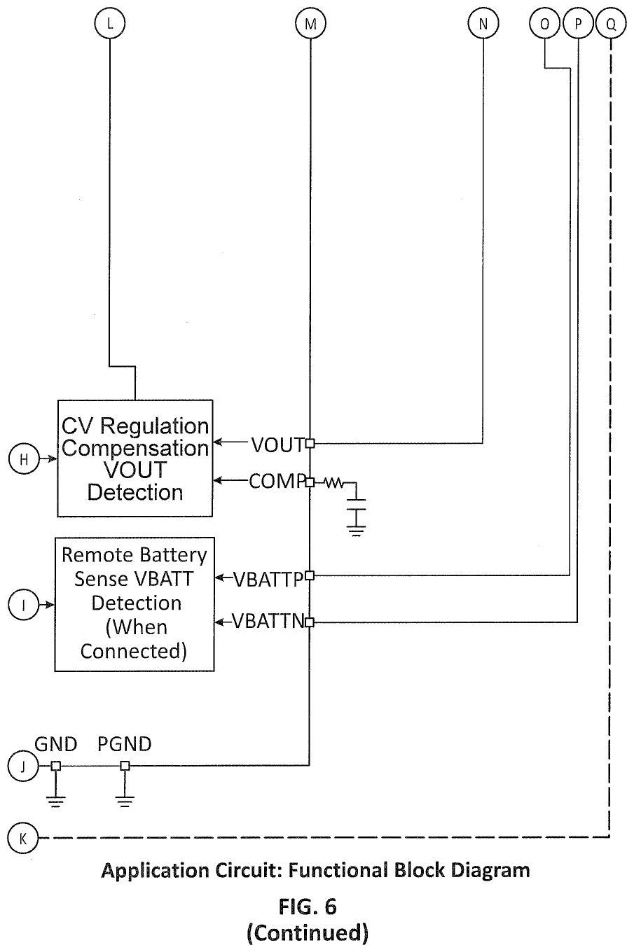

FIGS. 1-6 illustrate various embodiments of a high efficiency 4-level step-down and step-up power converter for battery charging applications, such as single cell Li-ion and Li-polymer battery applications. In the illustrated embodiments, the power converter is configured to deliver up to 5 amperes (A) of charging current in regulation mode and in a divide-by-3 charge pump mode, though other configurations are within the scope of the present disclosure. The power converter can be configured, for example, into dual ICs operation for 9 A charging current in regulation mode and in divide-by-3 charge pump mode. Although a 4-level power converter is illustrated, it will be appreciated that the embodiments described herein may be applicable to various M-level implementations, where M>=3.

In some implementations, for example, the power converter may supply an input range of approximately 4.5 V to 18 V input to support both universal serial bus (USB) and wireless inputs, and in a reverse step-up mode, the output may be programmable from 4.8 V to 16 V in 100 mV step with a programmable output current limit up to 1.7 A. This input voltage range may be used, for example, to support fast charging of single Li-Ion cells from USB and wireless input. It will be appreciated that other voltage and current ranges and limits may be implemented depending on the application. It will also be appreciated that while compatibility with USB is described herein, other wired interfaces and protocols may be implemented with the power converter of the present disclosure.

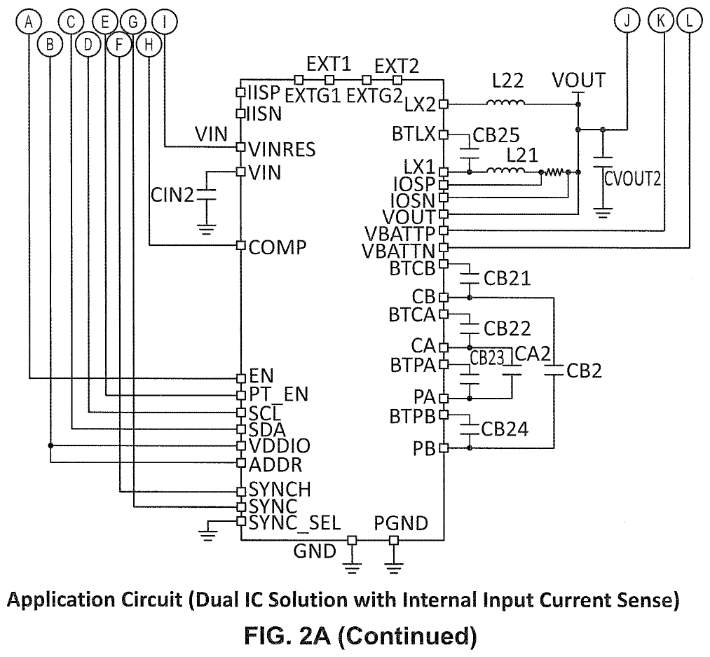

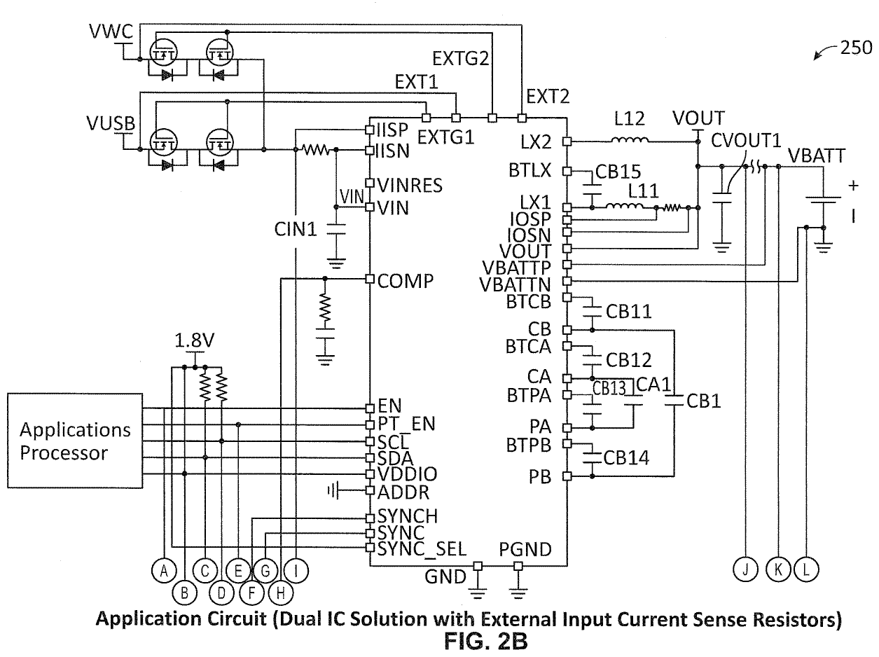

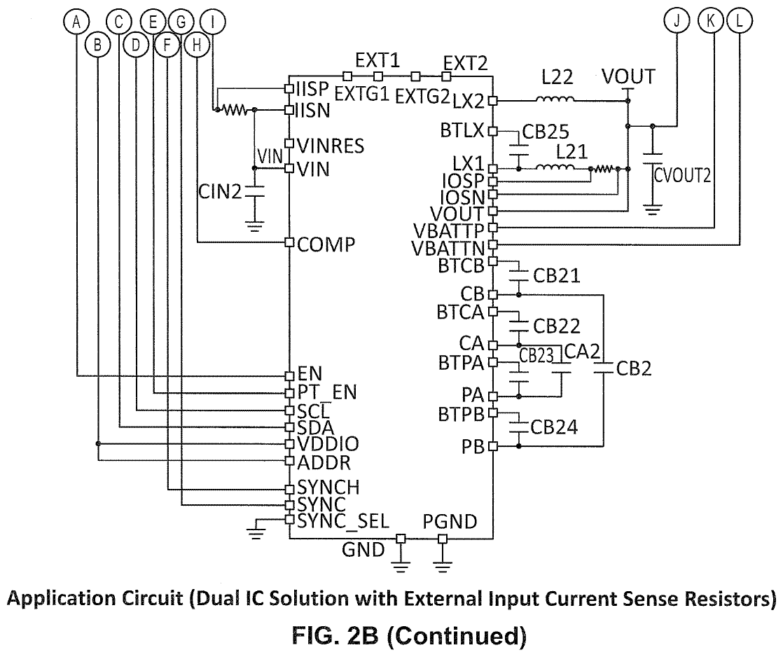

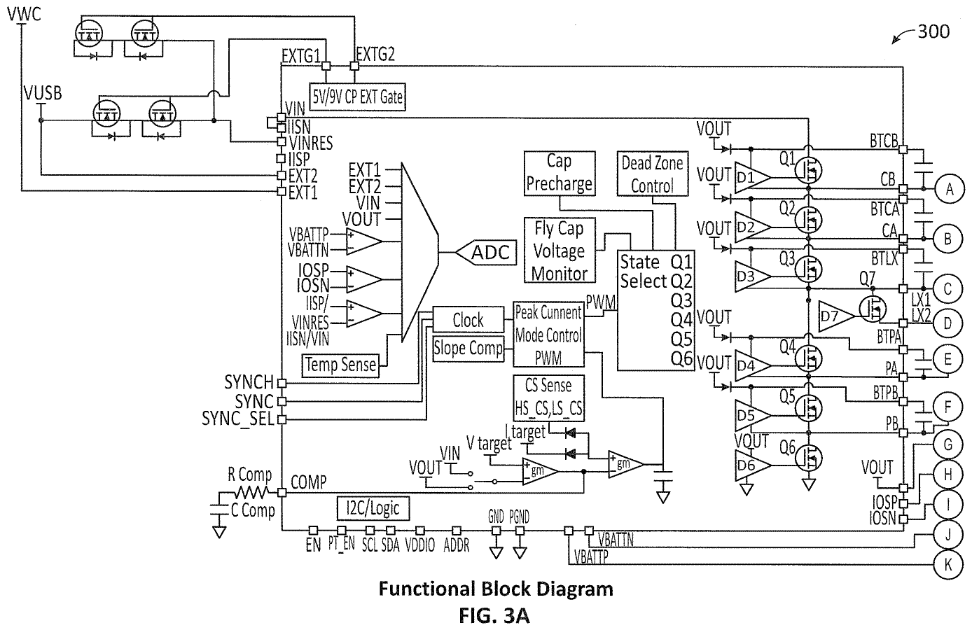

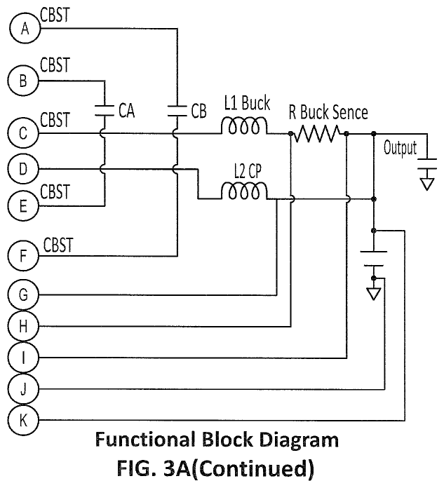

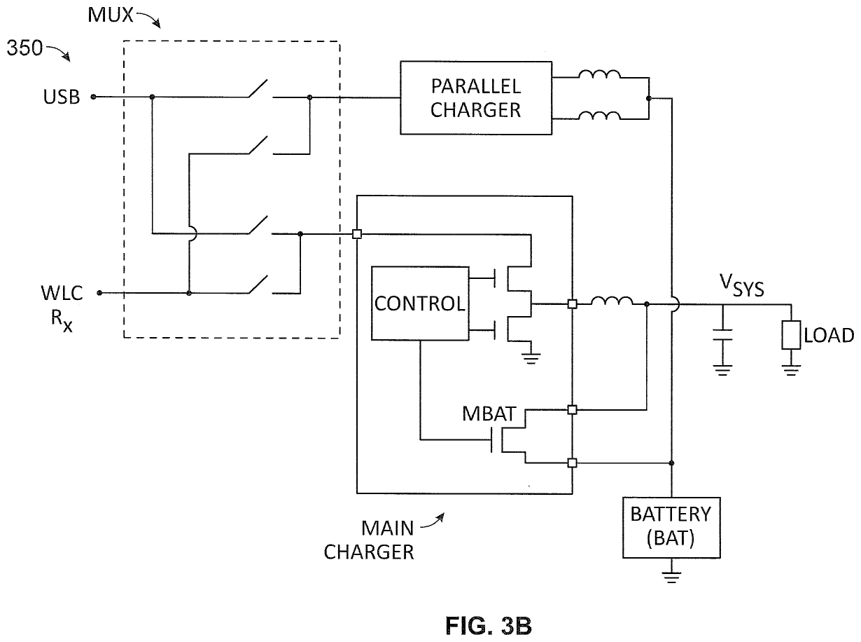

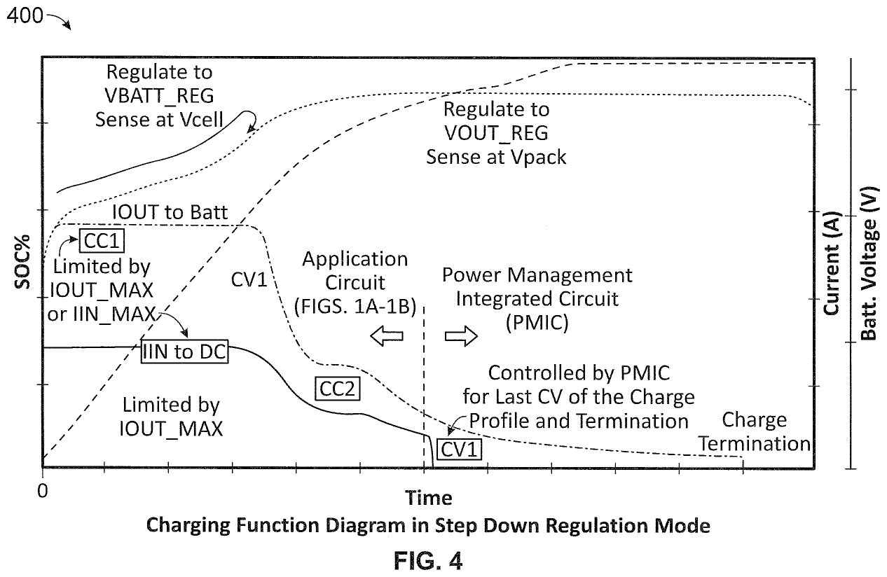

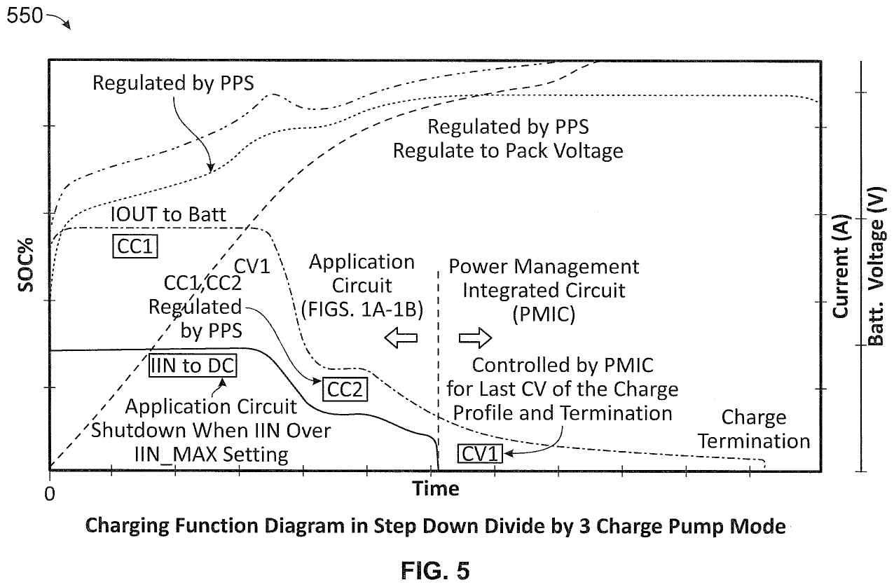

In various embodiments, the power converter may be implemented as a single integrated circuit (IC) (see, e.g., FIGS. 1A-B), dual-integrated circuits (see, e.g., FIGS. 2A-B), or in other configurations depending on the implementation. In various embodiments, the power converter may operate as a parallel charger along with a main charger, as shown in FIG. 3B, to provide the desired functionality noted herein and, for example, as illustrated in FIGS. 4 and 5 for the desired charging functionality for various applications, as would be understood by one skilled in the art. FIG. 3B may represent a system level point of view of a mobile architecture having a parallel charger and a main charger that accepts power from a wired port (e.g., a wired USB) or from a wireless interface. The parallel charger for one or more embodiments may represent an IC as illustrated in FIGS. 1-3A, for example, and may function to charge a battery for some portion of the charging profile (e.g., as shown in FIGS. 4 and 5), while the main charger charges the battery for other portions of the charging profile. In various embodiments, the parallel charger may also be configured to function as the main charger as well, depending upon the desired application. The novel architecture disclosed herein may be implemented to enable (i) improved efficiency (e.g., at 9 A charging current) in a low-profile solution; (ii) low electromagnetic interference (EMI) fixed-frequency operation under heavy load conditions; (iii) input and output current and voltage, IC temperature monitoring and telemetry via inter-integrated circuit (I₂C) technology; and/or (iv) full protection including input and output under voltage lockout (UVLO), input and output over voltage protection (OVP), input and output over current protection (OCP), and IC over-temperature with fault and warning status. In some implementations, the power converter supports divide-by-3, step-down and step-up regulating modes, dual external disconnect switch control, and/or paralleled operation.

In the illustrated embodiments, the power converter is implemented as a multi-level charge pump incorporating power switches and control circuitry. The power converter's internal bias may be provided by the system battery through a V_{OUT} connection (e.g., pin). The charging input can be USB (or other wired input) or wireless input by an external FET register control. In some implementations, the power converter may be programmed to different operating modes, which may include a step-down regulation mode, a step-down divide-by-3 charge pump mode, and a reverse step-up mode.

In a step-down regulation mode, the power converter operates as a multi-level step-down regulator to support USB power delivery (USB-PD) (or other wired protocol) or fixed input charging. During a constant-current (CC) phase, the maximum charging current may be limited for example, by configuring registers. When the input current does not reach a predetermined maximum input setting, the charge current is set to a predetermined maximum output setting. If the input current reaches the input maximum setting, then the charge current throttles and maintains input current at the input maximum setting. This allows maximum charging current while ensuring that the charge current does not go above a battery maximum current rating and the input current does not trip adapter over-current protection.

During a constant-voltage (CV) phase, the CV regulation may be limited, for example, by configuring registers. In operation, a single-wire sense pin or other sensor is configured to sense the output voltage V_{OUT}, which is compared to a predetermined value stored in a register, VOUT_REG. The voltage differential between the battery's positive terminal and negative terminal is sensed and compared to a predetermined value stored in a register, VBATT_REG. In some implementations, a single-wire sense pin or other sensor senses VBATTP (battery voltage at positive terminal) and a single-wire sense pin or other sensor senses VBATTN (battery volage at negative terminal). The CV regulates to the lower of the two settings. If the V_{OUT} sensed voltage reaches VOUT_REG first, then CV is regulated to VOUT_REG. If the VBATTP sensed voltage reaches VBATT_REG first, then CV is regulated to VBATT_REG. This provides a fast battery top off while preventing voltage above safety limit.

In a step-down divide-by-3 charge pump mode (which may be selected, for example, by setting a corresponding register), the power converter is configured as a divide-by-3 step-down charge divider to support USB-Programmable Power Supply (USB-PPS) or other charging protocol or programmable input charging. In some embodiments, the power converter allows the USB-PPS adapter to control voltage and current and ignores conflicting settings (e.g., settings stored in registers for IOUT_MAX, VOUT_REG and VBATT_REG). In this mode, the power converter monitors an IIN_MAX setting, shuts down the power train (which includes switches to configure, enable and disable various modes of operation) and disconnects external FET when IIN current exceeds IIN_MAX setting. In the illustrated embodiment, the output current is up to 10 A in dual IC operation and 5 A in single IC operation.

In a reverse step-up mode (which may be selected, for example, by setting a corresponding register) the power converter is configured as a multi-level step-up regulator to power peripheral device(s) connected to USB (or other wired protocol or standard) or wireless input. The power converter draws power from the system battery and regulates VIN to the VOUT_REG programmable setting of 4.8V to 16V. The VIN output current limit may be set, for example, by an IIN_MAX register.

In some embodiments, to enable the IC, both an EN pin and an IC_EN bit are set to logic high (1). When either the EN pin or IC_EN bit is set to logic low (0), the IC is disabled. After the IC is enabled, the POR status bit sets to 1 to indicate the IC has a fresh power up.

In some embodiments, the power converter provides a gate driver to control two external N-channel MOSFETs and sense inputs to monitor source input voltage at each FET. The external FETs may be controlled by registers (e.g., 1-bit registers V_EXTG, EXTG_EN and EXTGX). The V_EXTG bit sets the gate drive voltage and can be set to 9V or 5V, in the illustrated embodiment. The EXTGX bits select which FET(s) to turn on. The EXTG_EN bit enables the gate driver to turn on the selected FET(s). In various embodiments, the external FET can be turned on or off independently from other IC operations except when the IC is disabled. The EXT_EN_IND status bit set to 1 when external FET is enabled. When a fault is detected and triggers a shutdown, the external FET may be turned off automatically. If EXT1 or EXT2 detects an OVP, then the respected FET would not turn on from the off mode.

In various embodiments, the power train is enabled after all the registers have been initialized and the target input external FET is turned on. Sufficient time based on capacitance on the power path may be configured between the external FET on time and the power train on time to minimize in-rush current. Next, both PT_EN pin and PT_EN bit are set to logic high (1) to turn on the power train. When either PT_EN pin or PT_EN pin is logic low, the power train is off. In dual IC operation, the slave IC power train may be configured to turn on first before the master IC. The COMP, SYNC and SYNCH pins from two ICs gate the power train and synchronize the operation. The SYNC_SEL pin sets the IC to master mode or slave mode. IC internal fault and programmable fault detection shuts down the power train operation when fault is detected.

In a reverse step-up mode (which may be selected, for example, by setting a corresponding register), the power converter is configured as a multi-level step-up regulator to power peripheral device(s) connected to USB (or other wired port) or wireless input. The power converter draws power from the system battery and regulates VIN pin to a VOUT_REG programmable setting of 4.8V to 16V. The VIN output current limit is set by IIN_MAX register.

To enable the IC, both the EN pin and IC_EN bit are set to logic high (1). When either EN pin or IC_EN bit is set to logic low (0), the IC is disabled. After the IC enables, the POR status bit sets to 1 to indicate the IC has a fresh power up. The power converter provides a gate driver to control two external N-channel MOSFETs and sense inputs to monitor source input voltage at each FET. The external FETs are controlled by register bits, such as V_EXTG, EXTG_EN and EXTGX. The V_EXTG bit sets the gate drive voltage and can be set to 9V or 5V, for example. The EXTGX bits select which FET(s) to turn on. The EXTG_EN bit enables the gate driver to turn on the selected FET(s). The external FET can be turned on or off independently from other IC operation except when the IC is disabled. The EXT_EN_IND status bit set to 1 when external FET is enabled.

When a fault is detected and triggers a shutdown, the external FET may be turned off automatically. If EXT1 or EXT2 detects an OVP, then the respective FET would not turn on from off mode. The power train is enabled after all the registers have been initialized and the target input external FET is turned on. Sufficient time based on capacitance on the power path should be given between external FET on time to power train on time to minimize in-rush current. Next, both PT_EN pin and PT_EN bit are set to logic high (1) to turn on the power train. When either PT_EN pin or PT_EN pin is logic low, the power train is off. In dual IC operation, the slave IC power train is turned on before the master IC. The COMP, SYNC and SYNCH pins from the two ICs gate the power train and synchronize the operation. SYNC_SEL pin sets the IC to master mode or slave mode. IC internal fault and programmable fault detection shuts down power train operation when a fault is detected.

In accordance with various embodiments, an example power converter initialization, an example power up sequence, and an example fault handling will now be described for the three different operating modes. In an example step-down regulation mode, the initialization and power up sequence uses EXT1 as an example. The same sequence may apply to EXT2 with the only change in EXTGX bit and related EXT2 register settings. First, pull EN to logic high and then set IC_EN bit=1 at 100 us(TBD) after EN is logic high to enable IC. IC startup from POR stage, POR bit reports 1 indicating fresh IC startup. Next, the POR bit is read to confirm the IC is enabled. The FREQUENCY register is then set to a desired setting. In dual IC operation, both ICs are set to the same frequency setting. The VOUT_REG register is set to the target regulation voltage on the V_{OUT} sense pin in CV operation. The VBATT_REG register is set to the target regulation voltage on the VBATTP sense pin in CV operation. The IOUT_MAX register is set to the target maximum charger current in CC operation, and the IIN_MAX register is set to a value below the adapter current limit. Next, the FAULT and WARNING registers was set to a desired setting. Each Fault and Warning enables at a different time based on IC status and operating mode. The WATCHDOG register is then set to a desired setting.

The MODE register and other related registers are set for step-down regulation mode, including power train setup and enablement of an external FET, while checking for faults. In a dual IC operation, the external FETs are controlled by the master IC. If a fault (e.g., OVP event) is detected, then a shutdown register may be set to “1” to indicate a fault shutdown event and a sequence to enable the external FET after the shutdown fault is initiated. Next, the power train is enabled. In a dual IC operation, the slave IC power train is turned on before the master IC. After the power train is enabled, a bit may be set to indicate that the power train is ready and charging the battery. In some embodiments, a watchdog timer may be set to periodically check the IC status during charging operation.

If a fault event is detected, then the IC determines which faults events were triggered, such as the power train may be set to enable but it is off due to fault(s), an external FET is set to enable but the FET is off due to fault(s). The shutdown procedure may include resetting register values and repeating setup steps of enabling the power train, external FET, or other component that is disabled due to a fault.

An example step-down divide-by-3 power converter mode initialization and power up sequence will now be described. The initialization and power up sequence uses EXT1 as an example, but it will be appreciated that the same sequence applies to EXT2 with a change in EXTGX bit and related EXT2 register settings. The EN is pulled to logic high and then IC_EN bit=1 at 100 us(TBD) after EN is logic high to enable IC. The IC starts up from POR stage, POR bit reports 1 indicating fresh IC startup. The POR bit is read to confirm the IC is enabled. The FREQUENCY register is set to a desired setting. In dual IC operation, both ICs are set to the same frequency setting. The IIN_MAX register is set to a value below the adapter current limit. VOUT_REG, VBATT_REG and IOUT_MAX registers are not used in step-down divide-by-3 charge pump mode. Voltage and current regulation in step-down divide-by-3 charge pump mode may be controlled by the PPS adapter. The FAULT, WARNING, and WATCHDOG registers are set to desired settings. Each Fault and Warning enables at different time based on IC status and operating mode.

The MODE register and other registers are set for step-down divide-by-three mode, including power train setup and external FET setup, while checking for faults. If a fault (e.g., OVP event) is detected, then a shutdown register may be set to “1” to indicate a fault shutdown event and a sequence to enable the power train or external FET, as appropriate, after the shutdown fault is initiated. Next, the power train is enabled. After the power train is enabled, a bit may be set to indicate that the power train is ready and charging the battery. In some embodiments, a watchdog timer may be set to periodically check the IC status during charging operation. Voltage and current regulation in step-down divide-by-3 charge pump mode may be controlled by the PPS adapter.

If a fault event is detected, then the IC determines which faults events were triggered, such as the power train may be set to enable but it is off due to fault(s), or an external FET is set to enable but the FET is off due to fault(s). The shutdown procedure may include resetting register values and repeating setup steps of enabling the power train, external FET, or other component that is disabled due to a fault.

An example reverse step-up mode initialization and power up sequence will now be described. This initialization and power up sequence uses EXT2 as an example, but the same sequence applies to EXT1 with the change in EXTGX bit and related EXT1 register setting. The value EN is pulled to logic high and then IC_EN bit is set to 1 at 100 us(TBD) after EN is logic high to enable IC. The IC starts up from the POR stage, and the POR bit reports 1 indicating a fresh IC startup. The POR bit is read to confirm the IC is enabled. Next, the FREQUENCY register is set to a desired setting. In dual IC operation, both ICs are set to the same frequency setting. The VOUT_REG register is set to the target regulation voltage at V_{IN}. Next, the IIN_MAX register is set to the target current limit. VBATT_REG and IOUT_MAX registers are not used in reverse step-up mode. FAULT, WARNING, and WATCHDOG registers are set to desired settings. Each Fault and Warning enables at a different time based on IC status and operating mode.

The MODE register and other registers are set for reverse step-up mode, including power train setup and external FET setup, while checking for faults. If a fault (e.g., OVP event) is detected, then a shutdown register may be set to “1” to indicate a fault shutdown event and a sequence to enable the power train or external FET, as appropriate, after the shutdown fault is initiated. Next, the power train is enabled. After the power train is enabled, a bit may be set to indicate that the power train is ready and charging the battery. In some embodiments, a watchdog timer may be set to periodically check the IC status during charging operation. Voltage and current regulation in step-down divide-by-3 charge pump mode may be controlled by the PPS adapter. In dual IC operation, the slave IC power train is turned on before the master IC and is controlled by the master IC.

If a fault event is detected, then the IC determines which faults events were triggered, such as the power train may be set to enable but it is off due to fault(s), or an external FET is set to enable but the FET is off due to fault(s). The shutdown procedure may include resetting register values and repeating setup steps of enabling the power train, external FET, or other component that is disabled due to a fault. The EXT2 or VIN pins are not configured to detect OVP as it is set as the output in reverse step-up mode. But if EXT2 or VIN pin detects an OVP event, then IC_STATUS1 and IC_STATUS2 would report the fault event.

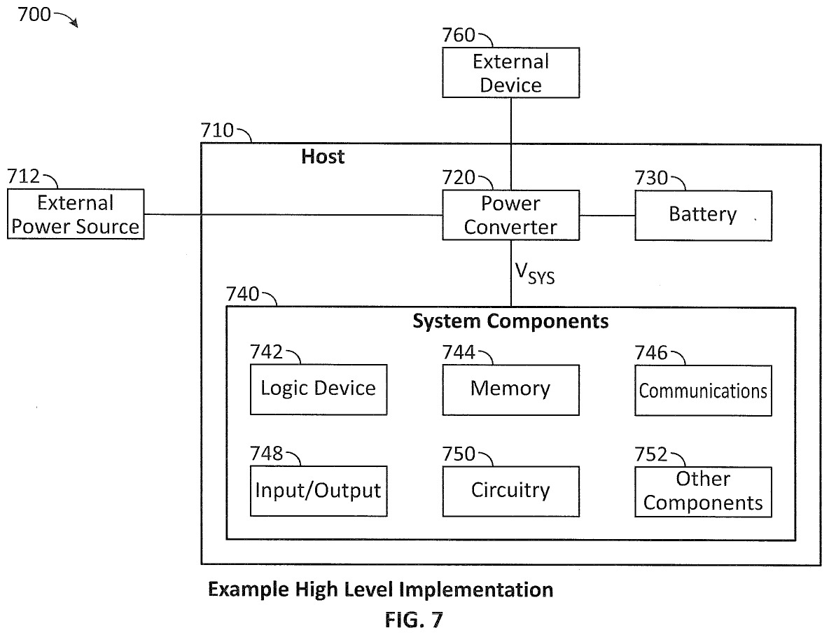

In an example system 700 illustrated in FIG. 7, a power converter 720 is implemented in a host 710 (e.g., a device or system) that includes a battery 730 and various system components 740. The host 710 may be any system or device that implements a power converter as described herein, including but not limited to a smart phone, tablet, portable electronics, a mobile device, low power electronics, and other electronic systems. The battery 730 may include one or more batteries that store electricity for use by the host 710, such as single cell Li-ion and Li-polymer batteries.

The power converter 720 may be configured to convert electricity stored in the battery 730 to a desired system voltage, Vsys, for powering various system components 740, which may include one or more logic devices 742, memories 744, communications components 746, input/output (I/O) components 748, circuitry 750, and other components 752. The power converter 720 may also supply power to one or more external devices 760, such as a component connected to the host 710 through a wired or wireless connection, such as a USB compatible device. The power converter 720 may also be configured to receive power from an external power source 712 and convert the received power to the battery 730 for storage, or to the system components 740 and/or external device 760, as applicable.

In various embodiments, the one or more logic devices 742 and memories 744 may be configured to perform operations of the host 710. A logic device 742 may be implemented as a general-purpose processor, a digital signal processor (DSP), an application-specific integrated circuit (ASIC), a microcontroller, a programmable logic device (PLD), a field-programmable gate array (FPGA), or other programmable logic device(s). The logic device 742 and other components may be configured through hardwiring, software execution, or a combination of both. In various embodiments, the host 710 includes one or more memory devices designed to retain data, such as software instructions for execution by the logic device. The memory may include volatile and non-volatile memories, such as random-access memory (RAM), dynamic RAM (DRAM), static RAM (SRAM), non-volatile random-access memory (NVRAM), read-only memory (ROM), programmable read-only memory (PROM), erasable programmable read-only memory (EPROM), electrically-erasable programmable read-only memory (EEPROM), flash memory, hard disk drives, or other memory types. The logic device may be configured to execute software instructions residing in the memory, thereby accomplishing method steps and operations.

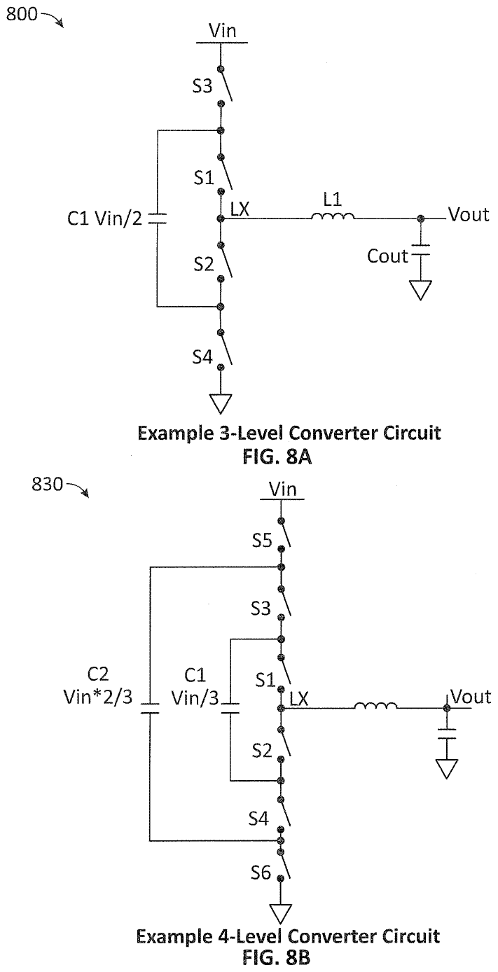

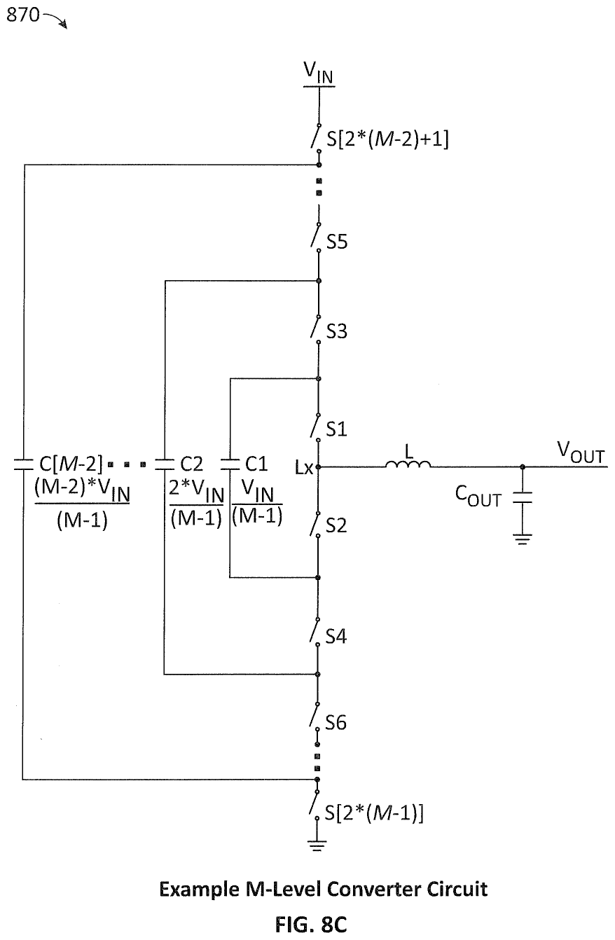

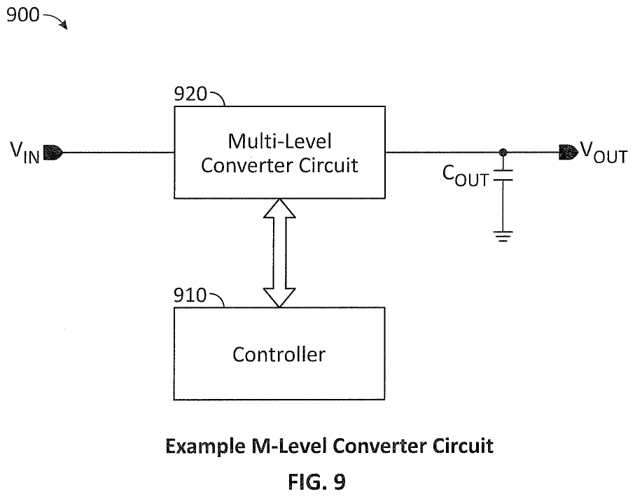

Referring to FIGS. 8A-8C, the converter circuit may be configured to switch between two or more switch states. One or more PWM duty cycle controllers may be provided to set the time in each switch state based on the voltage at V_{OUT}. For example, FIG. 8A is a schematic diagram of a 3-level DC-to-DC buck converter circuit 800 that may be used as the converter circuit 920 of FIG. 9. A set of four switches, S1-S4, is series-coupled between VIN and circuit ground. A fly capacitor C1 is coupled in series with switches S3 and S4, and in parallel with switches S1 and S2. An inductor L1 is coupled to an output capacitor C_{OUT} and to a node L_{X} between switches S1 and S2, and the voltage across the output capacitor COUT is V_{OUT}.

In the illustrated example, the presence of the single fly capacitor C1 in the converter circuit 800 enables four switch states that each generate one of three voltage levels at node Lx. In a first switch state, S2 and S4 are closed and S1 and S3 are open, effectively bypassing C1 and connecting L_{X} to circuit ground (voltage level at L_{X}=GND). In a second switch state, S2 and S4 are open and S1 and S3 are closed, effectively bypassing C1 and connecting L_{X} to VIN (voltage level at L_{X}=V_{IN}). In a third switch state S1 and S4 are open and S2 and S3 are closed, connecting C1 from VIN to LX, and thus charging C1 with inductor L1 current flowing into a load. The voltage across C1 will be about VIN/2 and the voltage level at L_{X} will also equal about VIN/2. In a fourth switch state, S1 and S4 are closed and S2 and S3 are open, connecting C1 from L_{X} to GND and thus discharging C1 with inductor L1 current flowing to a load. The voltage across C1 will be about VIN/2 and the voltage level at L_{X} will also equal about VIN/2 (e.g., this may assume that C1 was previously charged in state three). Accordingly, the illustrated converter circuit 800 has two switch states that generate a voltage level of VIN/2 at the L_{X} node.

If the converter circuit 800 is toggled between switch states three and four (avoiding switch state two that bypasses the fly capacitor C1), the inductor L1 sees small jumps in the voltage level at Lx, going from GND to only VIN/2 and back to GND, which results in reduced voltage ripple across the inductor L1 and less filtering to smooth V_{OUT} than a converter circuit with only S1 and S2 switches.

Adding additional series switches Sx and fly capacitors Cx to the 2-level converter circuit 800 increases the number of switch states and resulting voltage levels between VIN and circuit ground that can be applied to the L_{X} node, thus generating an even smaller voltage ripple across the inductor L. This reduces the filtering requirements to get a smooth output voltage. For example, a 4-level DC-to-DC buck converter circuit (see, e.g., FIG. 8B) includes 6 series-coupled switches S1-S6 and two fly capacitors Cx (X=2). Consequently, a 4-level converter circuit can define 4 voltage levels (VIN, GND, ⅓VIN, and ⅔V_{IN}) at node LX from 8 switch states (3 switch states result in the ⅓VIN level at Lx, and 3 other switch states result in the ⅔VIN level at Lx). For some applications, V_{OUT} is set low enough that the voltage level at node L_{X} alternates between GND and the next higher voltage level available. For higher output voltages, the switching pattern may never use GND. For example, in a 4-level converter circuit, an output V_{OUT} set to 0.5*VIN can be achieved by alternating the L_{X} node between ⅔ VIN and ⅓ V.

A different interpretation of a multi-level converter circuit is that the fly capacitors Cx create a charge-pump for the buck converter circuit. Unlike a standard charge-pump where the output is restricted to one output, a multi-level converter circuit allows the fly capacitors Cx to be coupled to create multiple intermediate voltages. For the 4-level example, the two fly capacitors each act as a ⅓ charge-pump with the additional benefit that any input voltage that is a sum of ⅓ ratios can be created, including VIN and GND.

A multi-level converter circuit couples the fly capacitors Cx in different combinations in order to bring the voltage level at the L_{X} node down or up. As noted above, when a fly capacitor is used (i.e., not bypassed), the electrical energy flowing through that fly capacitor generally will either charge it or discharge it, which creates a control problem in maintaining an average voltage.

Resolving the charge-balance problem so as to maintain an average voltage across the single capacitor in a 3-level converter circuit will now be described. For example, in a 3-level converter circuit, one way to generate the Level-1 (GND) and Level-3 (V_{IN}) voltage levels at the L_{X} node is to not use the fly capacitors C1 for these L_{X} voltage levels. However, for the Level 2 (VIN/2) voltage level at Lx, two separate switch states can be used: one switch state charges the capacitor (S3 and S2 closed, S1 and S4 open) and the other switch state discharges the capacitor (S3 and S2 open, S1 and S4 closed). The control of a 3-level converter circuit may operate such that each time the converter circuit switches states to Level-2, a controller can alternate between charging and discharging the single capacitor to maintain its voltage. A voltage comparator can be used to monitor the capacitor to help decide on a charging state or a discharging state. For instance, if the capacitor voltage is below VIN/2, then a controller would select charge (the third switch state), and if the capacitor voltage is above VIN/2, then the controller would select discharge (the fourth switch state).

Referring to FIGS. 8B, a 4-level converter circuit 830 (X=2) illustrates the charge-balance difficulty when more capacitors are present. A Level-1 voltage level (GND) and a Level-4 voltage level (V_{IN}) at the L_{X} node are each determined by a single switch state. However, the Level-2 voltage level (⅓ V_{IN}) and Level-3 voltage level (⅔ V_{IN}) at L_{X} each can be achieved by any of three different switch states. At higher orders of a multi-level converter circuit (X>2), more switch states are possible for generating the intermediate levels between VIN and GND. The problem gets more complicated with a 5-level converter circuit (X=3). A Level-1 voltage level (GND) and a Level-5 voltage level (V_{IN}) at the L_{X} node are each determined by a single switch state. However, the Level-2 voltage level (¼V_{IN}) and Level-4 voltage level (¾ V_{IN}) at L_{X} each can be achieved by any of four different switch states, the Level-3 voltage level ( 2/4 V_{IN}) at L_{X} can be achieved by any of six different switch states.

As should be clear from these examples, determining a suitable charge-balance method can become exceedingly difficult as the complexity of a multi-level converter circuit increases. As previously noted, most conventional control methods rely on establishing a sequence of linked state-changes to try to achieve charge balance. Control systems based on long sequences of switch states generally assume that all system variables—such as input voltage and output current—are constant during the sequence. This is unrealistic for a real-world environment, where all system variables tend to be dynamic.

In a 2-Level example, the converter circuit switches between two switch states: S1 closed and S2 open (voltage level at L_{X}=V_{IN}), or S1 open and S2 closed (voltage level at L_{X}=GND). A PWM duty cycle controller sets the time in each switch state based on the voltage at V_{OUT}, which determines the amplitude of the average voltage at L_{X} (noting that, the average L_{X} voltage in theory is equal to the V_{OUT} average voltage, but that, due to parasitics, the L_{X} average voltage is higher and/or lower (for negative currents) than the V_{OUT} average). As can be appreciated, the inductor L sees large jumps in the voltage level at Lx, from GND to V_{IN} and back to GND. The resulting voltage ripple across the inductor L necessitates a significant amount of filtering to smooth V_{OUT}.

An alternative way of reducing the voltage ripple across the inductor L is to add more series switches as well as charge transfer capacitors as energy storage elements to transfer charge from V_{IN} to V_{OUT}. As noted above, such charge transfer capacitors are commonly known as “fly capacitors” or “pump capacitors” and may be external components coupled to an integrated circuit embodiment of a converter circuit. The presence of X fly capacitors Cx defines a multi-level capacitive converter circuit capable of generating M=X+2 voltage levels at node L_{X} from 2^{(X+1)} switch states.

FIG. 8C is schematic diagram of a generalized M-level multi-level converter cell 870 that may be used as the converter circuit 920 of FIG. 9. A set of switches, S1-S[2*(M−1)], is series-coupled between VIN and circuit ground. The set of switches are organized in switch pairs: S1 & S2, S3 & S4, . . . S[2*(M−2)+1]& S[2*(M−1)]. A set of M−2 fly capacitor Cx is coupled in series with certain respective switches, and in parallel with switches in between those switches. In terms of switch pairs, there are M−1 pairs of switches, or one more than the number of fly capacitors. An optional inductor L is coupled to an output capacitor C_{OUT} and to a node L_{X} between switches S1 and S2, and again the voltage across the output capacitor C_{OUT} is V_{OUT}. The inductor L doubles as a virtual current source that facilitates movement of charge between the fly capacitors Cx. This creates a very efficient form of charge transfer, but introduces the problem of charge-balancing the fly capacitors Cx.

In various embodiments, each fly capacitor Cx has a first terminal coupled between an outer high-side switch S[2*x+1] and an inner high-side switch S[2*x−1], where “high-side” refers to the V_{IN} side of the converter circuit. Each fly capacitor Cx has a second terminal coupled between an outer low-side switch S[2*x+2] and an inner low-side switch S[2*x], where “low-side” refers to the circuit ground (GND) side of the converter circuit. Thus, for an M=3 multi-level converter cell, a first terminal of the single (X=1) fly capacitor C1 would be coupled between outer high-side switch S3 and inner high-side switch S1, and a second terminal of the capacitor C1 would be coupled between inner low-side switch S2 and outer low-side switch S4. Accordingly, each fly capacitor Cx within the multi-level converter cell 870 has four switches that can affect current flow through that fly capacitor Cx.

In some embodiments, a voltage detector, which may be a simple comparator-type circuit, is provided to sense the voltage across a corresponding fly capacitor Cx with respect to a reference voltage, V_{REF}, which represents a desired target voltage for the fly capacitor Cx. Every fly capacitor Cx may have a target average voltage in order to maintain proper output level. For an M-level converter and capacitor Cx, where x=1, 2, . . . [M−2], its target voltage is:

$$Vtarget [ Cx ] = {V}_{IN} ⋆ \frac{x}{M - 1}$$

The voltage detector may be configured to output a HIGH/LOW status signal, C_{Fx_H/L}, indicating with the voltage across the corresponding fly capacitor Cx is greater than V_{REF} or less than V_{REF}. The C_{Fx_H/L} status signal is coupled to control circuitry for the switches associated with the fly capacitor Cx.

The control circuitry for the four switches that can affect current flow through a fly capacitor Cx set states for those switches in part as a function of the voltage across the fly capacitor Cx as measured by the associated voltage detector and conveyed by the C_{Fx_H/L}x status signal. Accordingly, for ease of understanding, it can be said that each fly capacitor Cx “controls” its own pairs of high-side and low-side switches. If it is assumed that current flow in the inductor is charging the output V_{OUT}, there are four possible states that can be defined for the pairs of high-side and low-side switches for each fly capacitor Cx.

In a switch state in which the outer high-side and inner low-side switches associated with fly capacitor Cx are closed and all other associated switches are open, fly capacitor Cx would be in a charging configuration (whether or not charging actually occurs may depend on the switch states for other fly capacitors Cx). In a switch state in which the inner high-side and outer low-side switches associated with fly capacitor Cx are closed and all other associated switches are open, fly capacitor Cx would be in a discharging configuration (whether or not discharging actually occurs may depend on the switch states for other fly capacitors Cx). In a switching state in which the inner low-side and outer low-side switches associated with fly capacitor Cx are closed and all other associated switches are open, fly capacitor Cx would be bypassed. In a switching state in which the outer high-side and inner high-side switches associated with fly capacitor Cx are closed and all other associated switches are open, fly capacitor Cx would again be bypassed.

While each fly capacitor Cx can control both of its own pairs of high-side and low-side switches, in general, methods of control disclosed herein may utilize either the outer switches or the inner switches controllable by each corresponding capacitor. For example, referring to FIG. 8B, in “outer-switch” methods, fly capacitor C1 will control its outer switches S3 and S4, fly capacitor C2 will control its outer switches S5 and S6, etc. Conversely, for example, in “inner-switch” methods, fly capacitor C1 will control its inner switches S1 and S2, fly capacitor C2 will control its inner switches S3 and S4, etc. The switch states of either pair (inner or outer) of switches controlled by a fly capacitor Cx may be complementary—that is, no fly capacitor Cx closes or opens both of its high-side and low-side controlled switches at the same time. If each fly capacitor Cx controls its outer-switches, then no fly capacitor controls the left-over innermost switches S1 and S2. If instead each fly capacitor Cx controls its inner-switches, then no fly capacitor controls the left-over outermost switches S[2*(M−1)] and S[2*(M−2)+1]. Switch states for the left-over switches are also complementary.

FIG. 9 is a high-level block diagram of an example circuit that includes a power converter 900, in accordance with one or more embodiments of the present disclosure. In the illustrated example, the power converter 900 includes a converter circuit 920 and a controller 910. The converter circuit 920 and controller 910 may be configured to implement, for example, any of the multi-level power converter circuits as previously described with reference to FIGS. 1A-8C, and as described further herein. In the illustrated embodiment, the converter circuit 920 is configured to receive an input voltage VIN from a voltage source and transform the input voltage VIN into an output voltage VOUT. In some embodiments of the power converter 900, auxiliary circuitry (not shown), such as a bias voltage generator(s), a clock generator, a voltage control circuit, etc., may also be present and coupled to the converter circuit 920 and the controller 910.

The controller 910 receives a set of input signals and produces a set of output signals. Some of these input signals arrive along a signal path connected to the converter circuit 920. These input signals carry information that is indicative of the operational state of the converter circuit 920. The controller 910 may also receive a clock signal CLK (for synchronous converter circuits 920) and one or more external input/output signals I/O that may be analog, digital (encoded or direct signal lines), or a combination of both. Based upon the received input signals, the controller 910 produces a set of control signals back to the converter circuit 920 that control the internal components of the converter circuit 920 (e.g., internal switches, such as low voltage FETs/MOSFETs) to cause the converter circuit 920 to boost or buck VIN to VOUT. In some embodiments, an auxiliary circuit (not shown) may provide various signals to the controller 910 (and optionally directly to the converter circuit 920), such as the clock signal CLK, the input/output signals I/O, as well as various voltages, such as a general supply voltage VDD and a transistor bias voltage VBIAS.

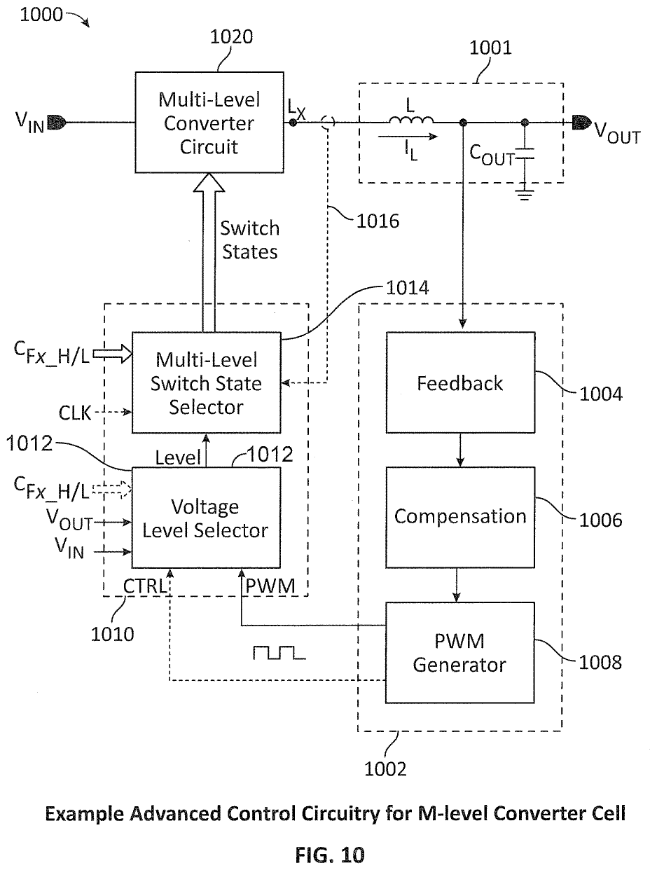

FIG. 10 is a block diagram of one embodiment of advanced control circuitry 1000 for an M-level converter cell 1000 such as the generalized version depicted in FIG. 8B. The M-level converter cell 1020 is shown coupled to an output block 1001 comprising an inductor L and an output capacitor C_{OUT} (conceptually, the inductor L also may be considered as being included within the M-level converter cell 1020). The advanced control circuitry 1000 functions as a control loop coupled to the output of the M-level converter cell 1020 and to switch control inputs of the M-level converter cell 1020. In general, the advanced control circuitry 1000 is configured to monitor the output (e.g., voltage and/or current) of the M-level converter cell 1020 and dynamically generate a set of switch control inputs to the M-level converter cell 1020 that attempt to stabilize the output voltage and/or current at specified values, taking into account variations of V_{IN} and output load. In alternative embodiments, the advanced control circuitry 1000 may be configured to monitor the input of the M-level converter cell 1020 (e.g., voltage and/or current) and/or an internal node of the M-level converter cell 1020 (e.g., the voltage across one or more fly capacitors or the current through one or more power switches). Accordingly, most generally, the advanced control circuitry 1000 may be configured to monitor the voltage and/or current of a node (e.g., input terminal, internal node, or output terminal) of the M-level converter cell 1020. The advanced control circuitry 1000 may be incorporated into, or separate from, the overall controller for a power converter 100 embodying the M-level converter cell 1020.

A first block comprises a feedback controller 1002, which may be a traditional controller such as a fixed frequency voltage mode or current mode controller, a constant-ON-time controller, a hysteretic controller, or any other variant. The feedback controller 1002 is shown as being coupled to V_{OUT} from the M-level converter cell 1020. In alternative embodiments, the feedback controller 1002 may be configured to monitor the input of the M-level converter cell 1020 and/or an internal node of the M-level converter cell 1020. The feedback controller 1002 produces a signal directly or indirectly indicative of the voltage at V_{OUT} that determines in general terms what needs to be done in the multi-level converter cell 1020 to maintain desired values for V_{OUT}: charge, discharge, or tri-state (i.e., open, with no current flow).

In the illustrated example, the feedback controller 1002 includes a feedback circuit 1004, a compensation circuit 1006, and a PWM generator 1008. The feedback circuit 1004 may include, for example, a feedback-loop voltage detector which compares V_{OUT} (or an attenuated version of V_{OUT}) to a reference voltage which represents a desired V_{OUT} target voltage (which may be dynamic) and outputs a control signal to indicate whether V_{OUT} is above or below the target voltage. The feedback-loop voltage detector may be implemented with a comparison device, such as an operational amplifier (op-amp) or transconductance amplifier (gm amplifier).

The compensation circuit 1006 is configured to stabilize the closed-loop response of the feedback controller 1002 by avoiding the unintentional creation of positive feedback, which may cause oscillation, and by controlling overshoot and ringing in the step response of the feedback controller 1002. The compensation circuit 1006 may be implemented in known manner, and may include LC and/or RC circuits.

The PWM generator 1008 generates the actual PWM control signal which ultimately sets the duty cycle of the switches of the multi-level converter cell 1020. In addition, in some embodiments, the PWM generator 1008 may pass on additional optional control signals CTRL indicating, for example, the magnitude of the difference between V_{OUT} and the reference voltage (thus indicating that some levels of the M-level converter cell 1020 should be bypassed to get to higher or lower levels), and the direction of that difference (e.g., whether V_{OUT} is greater than or less than the reference voltage). In other embodiments, the optional control signals CTRL can be derived from the output of the compensation circuit 1006, or from the output of the feedback circuit 1004, or from a separate comparator (not shown) coupled to, for example, V_{OUT}. One purpose of the optional control signals CTRL is for advanced control algorithms, when it may be beneficial to know how far away V_{OUT} is from a target output voltage, thus allowing faster charging of the inductor L if the V_{OUT} is severely under regulated.

A second block comprises a multi-level controller 1010, the primary function of which is to select the switch states that generate a desired V_{OUT} while maintaining a charge-balance state on the fly capacitors within the M-level converter cell 1020 every time an output voltage level is selected, regardless of what switch state or states were used in the past.

The multi-level controller 1010 includes a Voltage Level Selector 1012 which receives the PWM control signal and the additional control signals CTRL if available. In addition, the Voltage Level Selector 1012 may be coupled to V_{OUT} and/or V_{IN}, and, in some embodiments, to the HIGH/LOW status signals, C_{Fx_H/L}, from the voltage detectors coupled to corresponding fly capacitors Cx within the M-level converter cell 1020. A function of the Voltage Level Selector 1012 is to translate the received signals to an output voltage Target Level (e.g., on a cycle-by-cycle basis). The Voltage Level Selector 1012 typically will consider at least V_{OUT} and VIN to determine which Target Level should charge or discharge the output of the M-level converter cell 1020 with a desired rate. For example, in a 6-level converter circuit, the available Target Levels are Level-1 (GND), Level-2 (⅕V_{IN}), Level-3 (⅖V_{IN}), Level-4 (⅗V_{IN}), Level-5 (⅘V_{IN}), and Level-6 (V_{IN}), which may be represented as a count value from 1-6 (or 0-5).

As an example, in a 4-Level converter circuit, if V_{IN}=12V and V_{OUT} nominally should be 3V, then the Voltage Level Selector 1012 may indicate that a Target Level of “2” can be selected, which results in a ⅓V_{IN} voltage level at L_{X} (i.e., 4V). The PWM control signal sets a duty cycle between that Target Level and another Target Level (e.g., GND) so that the average voltage level at L_{X} will be about 3V.

In general, for steady-state operations, the Target Level voltage closest to V_{OUT} that either charges or discharges the inductor L may be selected for simplicity of the selection algorithm. In general, for transient response, a Target Level that is higher (for charging) or lower (for discharging) than the closest Target Level may be selected to quickly charge or discharge the inductor L. The Voltage Level Selector 1012 may be implemented, for example, as a look-up table (LUT) or as comparison circuitry and combinatorial logic or more generalized processor circuitry. In some embodiments, the Voltage Level Selector 1012 can implement advanced methods (described below) that try to speed up charging or discharging based on additional factors, such as inductor voltage drop, load transients, the magnitude of output deviations, and/or external input signals from external sources. The output of the Voltage Level Selector 1012 may include duty cycle information (e.g., derived from the input PWM control signal) as well as switch state.

The output of the Voltage Level Selector 1012 is coupled to a Multi-Level Switch State Selector 1014, which generally would be coupled to the status signals, C_{Fx_H/L}, from the voltage detectors for the fly capacitors Cx. Taking into account the Target Level generated by the Voltage Level Selector 1012, the Multi-Level Switch State Selector 1014 determines a pattern of switch states for the desired output level that generally achieves charge-balancing the fly capacitors Cx. The Multi-Level Switch State Selector 1014 may be implemented, for example, as comparison circuitry and combinatorial logic, as a look-up table (LUT), or as more generalized processor circuitry. The output of the Multi-Level Switch State Selector 1014 is coupled to the switches of the multi-level converter cell 1020 (through appropriate level-shifter circuits and drivers circuits, as may be needed for a particular converter cell) and includes a pattern of switch state settings determined by the Multi-Level Switch State Selector 1014. The pattern of switch state settings selects the configuration of the switches within the multi-level converter cell 1020.

In general (but not always), for PWM-based control systems, the Voltage Level Selector 1012 and the M-level Switch State Selector 1014 only change their states when the PWM signal changes. For example, when the PWM signal goes high, the Voltage Level Selector 1012 selects which level results in charging of the inductor L and the M-level Switch State Selector 1014 sets which version to use of that level. Then when the PWM signal goes low, the Voltage Level Selector 1012 selects which level can discharge the inductor L and the M-level Switch State Selector 1014 sets which version of that level to use. Thus, the Voltage Level Selector 1012 and the M-level Switch State Selector 1014 generally only change states when the PWM signal changes (the PWM signal is in effect their clock signal). However, there may be situations or events where it is desirable for the CTRL signal to change the state of the Voltage Level Selector 1012. Further, there may be situations or events where it is desirable for the C_{Fx_H/L} status signal(s) to cause the M-level Switch State Selector 1014 to select a particular configuration of power switch settings, such as when a severe mid-cycle imbalance occurs. In some embodiments, it may be useful to include a timing function that forces the M-level Switch State Selector 1014 to re-evaluate the optimal version of the state periodically, for example, in order to avoid being “stuck” at one level for a very long time, potentially causing charge imbalances.

One notable benefit of the control circuitry shown in FIG. 10 is that it enables generation of voltages in boundary zones between voltage levels, which represent unattainable output voltages for conventional multi-level DC-to-DC converter circuits.

In alternative unregulated charge-pumps embodiments, the feedback controller 1002 and the Voltage Level Selector 1012 may be omitted, and instead a clock signal CLK may be applied to the M-level Switch State Selector 1014. The M-level Switch State Selector 1014 would generate a pattern of switch state settings that periodically charge balances the fly capacitors Cx regardless of what switch state or states were used in the past (as opposed to cycling through a pre-defined sequency of states). This ensures that if V_{IN} changes or anomalous evens occur, the system generally always seeks charge balance for the fly capacitors Cx.

In some embodiments, the M-level Switch State Selector 1014 may take into account the current I_{L} flowing through the inductor L by way of an optional current-measurement input 1016, which may be implemented in conventional fashion.

In an M-level multi-level converter circuit, the configuration of switches that achieves Level-1 (e.g., GND) or Level-M (e.g., V_{IN}) effectively bypasses the fly capacitors Cx. Conversely, for all intermediate voltage levels, at least one fly capacitor Cx is coupled to VOUT and there are always at least two configurations of switches that can achieve any intermediate voltage level. For any particular intermediate voltage level, at least one configuration of switches results in charging the associated fly capacitor and at least one other configuration of switches results in discharging the associated fly capacitor. One aspect of the present disclosure is the realization that any achievable output voltage V_{OUT} requiring intermediate voltage levels can be attained by dynamically selecting patterns of switch configurations—that is, by selecting switch configurations without regard to or memory of the switch configurations of any previous switching cycle—to select appropriate Levels, and doing so in a way that purposefully selects either charging or discharging switch configurations that also balance charge across the fly capacitors Cx.

Embodiments of the disclosure use the following approach for positive inductor L current (charging V_{OUT}):
(1) a fly capacitor Cx that needs charging will be set to close its charging switch (the outer high-side switch in outer-switch control methods, or the inner low-side switch for inner-switch control methods); and
(2) a fly capacitor Cx that needs discharging will be set to close its discharging switch (the outer low-side switch for outer-switch control methods, or the inner high-side switch for inner-switch control methods).

For negative inductor L current (discharging V_{OUT}), the selection of switches inverts. Accordingly:
(1) a fly capacitor Cx that needs charging will be set to close its charging switch (the outer low-side switch in outer-switch control methods, or the inner high-side switch for inner-switch control methods); and
(2) a fly capacitor Cx that needs discharging will be set to close its discharging switch (the outer high-side switch for outer-switch control methods, or the inner low-side switch for inner-switch control methods).

Note again that whether or not charging actually occurs for a particular fly capacitor Cx generally depends on the switch states for all other fly capacitors. For a fly capacitor C(x) to actually charge or discharge, the next inward (if one exists) fly capacitor C(x−1) (for outer-switch control methods) or the previous outward (if one exists) fly capacitor C(x+1) (for inner-switch control methods) must be set to the opposite state (i.e., discharge or charge) so that a bypass situation does not occur.

For any multi-level converter circuit of order M that can create M voltage levels—i.e., Level-1 (e.g., GND) through Level-M (e.g., V_{IN})—then the following switch count rules apply for any Level-m:
(1) M−m low-side switches must be set to be closed (ON);
(2) m−1 high-side switches must be set to be closed (ON); and
(3) switches that are not required to be ON must be set to be OFF (open).

With these switch count rules in mind, the following generalized capacitor control method applies for each state change of the Multi-Level Switch State Selector 1014:
Step 1) Select a fly capacitor that has not previously been selected;
Step 2) If the voltage of the selected fly capacitor is above its Vtarget and there are remaining (i.e., not been set by this method in this cycle) low-side or high-side switches that can be set to be closed to enable a discharge path for the selected fly capacitor, then set those switches that enable a discharge path for the selected fly capacitor to be closed, decrement one or more appropriate counters (e.g., for the number of low-side switches set to be closed and the number of high-side switches set to be closed), and flag the current fly capacitor as “done” (i.e., as having been selected); otherwise (since the voltage of the selected fly capacitor is below its Vtarget) set the switches that enable a charging path for the selected fly capacitor to be closed and flag the current fly capacitor as “done”;
Step 3) Loop to Step 1 until all fly capacitors have been selected;
Step 4) For the remaining pair of left-over switches, set the high-side switch or the low-side switch to be closed based on the switch count rules and the counter values.

With the above generalized capacitor control method, more specific multi-level charge-balancing control methods can be created. Examples can be found, for example, in U.S. Patent Publication No. 20230148059, which is incorporated by reference herein in its entirety.

As previously discussed, a multi-level converter circuit may be implemented in various host systems and devices and may be configurable to operate in various modes (e.g., boost mode, buck mode, charge pump mode), with various voltage sources and loads, and with various input and/or output voltage levels. Referring back to FIG. 1A, when a multi-level converter circuit 100 initiates a startup sequence, a first voltage level (e.g., V_{IN}) may be present at a first terminal (e.g., VINRES) that may be electrically coupled to a wired or wireless power supply (e.g. VUSB or VWC), and a second voltage level (e.g., VOUT) may be present at a second terminal (e.g., LX1, LX2) which may be electrically coupled to a load (e.g., a battery). If the internal voltage at the first terminal is significantly different than the first voltage level, or the internal voltage at the second terminal is significantly different than the second voltage level, then it may cause large inrush or backflow currents that can damage one or more circuit components.

When operating as a buck converter, for example, the multi-level converter 1100 receives a supply voltage (V_{IN}) from a voltage source. In the illustrated embodiment, the voltage source may include a voltage source connected through a USB port generating voltage VUSB or a wireless voltage supply such as a wireless charger generating VWC. The wired and/or wireless voltage supply may be selectively routed to VIN through one or more external switches, such as the illustrated FETs controlled by the multi-level converter 100.

When operating in a buck mode, the multi-level converter may be configured to receive the input voltage VIN from the voltage supply and deliver an output voltage V_{OUT} to the load, such as the battery in the illustrated embodiment. When starting in the buck mode, the input voltage VIN and an internal voltage at the input terminal, VINRES, may be substantially the same. In a charge pump or boost mode, however, the current flows from the V_{OUT} to VIN and the relatively large input voltage VIN may generate inrush current until the internal voltage at VINRES approaches a target voltage level.

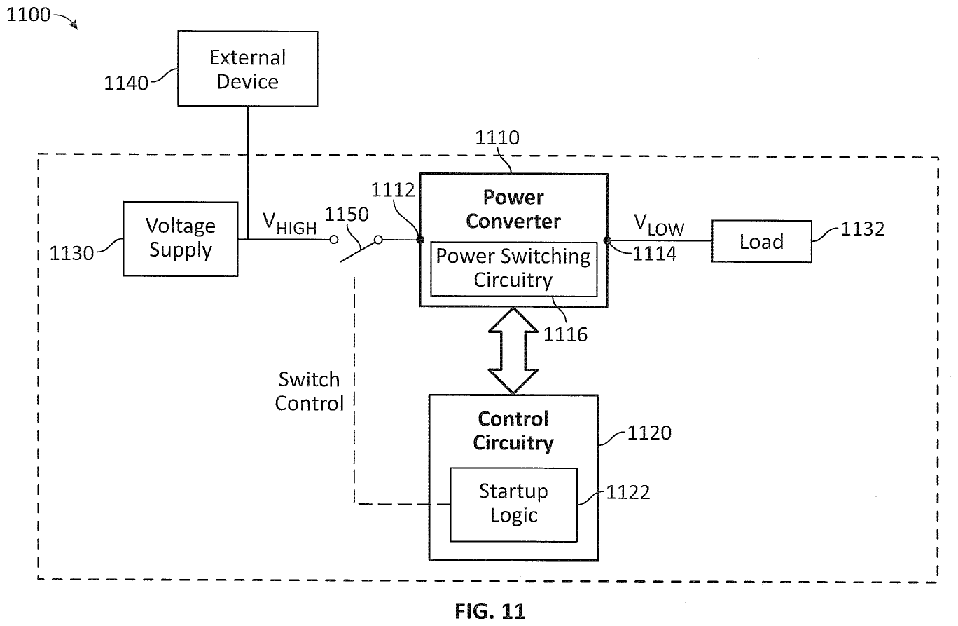

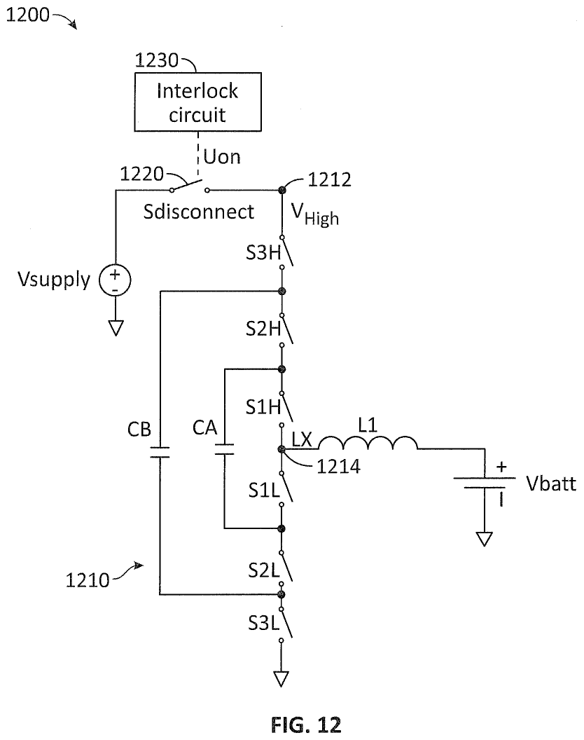

Referring to FIGS. 11-15, systems and methods for mitigating inrush and/or backflow current of a power converter will now be described in accordance with embodiments of the present disclosure. FIG. 11 is a high-level block diagram illustrating inrush and/or backflow mitigation circuitry, in accordance with one or more embodiments of the present disclosure. A system 1100 includes a power converter 1110, including power switching circuitry 1116 (e.g., as described with reference to FIGS. 8A-C or FIG. 12 or other power switching circuitry) configurable to selectively route a first voltage between a first terminal 1112 and a second terminal 1114.

As illustrated, the first terminal 1112 is electrically couplable to a voltage supply 1130, which supplies a voltage VHIGH to the power converter 1110. Control circuitry 1120 is configurable to selectively operate the power switch circuitry 1116 to generate a second voltage from the first voltage by charging and/or discharging one or more capacitors (e.g., as illustrated and described with reference to FIGS. 1A-3, 6, 8A-8C and 12) in accordance with one or more configurations and/or modes of operation. In some embodiments, the power converter 1110 is configurable to receive the supply voltage VHIGH and generate an output voltage VLOW which is delivered to a load 1132 (e.g., a battery or other load). In some embodiments, the power converter 1110 is configurable to receive a voltage from the load 1132 at the second terminal 1114, and generate an output voltage which may, for example, be delivered to another component or device, such as an external device 1140. It will be appreciated that while multi-level power converters are described herein, the power converter 1110 may include any type of power converter configurable to receive a voltage from the load 1132 and generate a higher voltage at the terminal 1112.

To mitigate inrush and/or backflow currents, a disconnect switch 1150 is coupled between the first terminal 1112 and the voltage supply 1130 selectively connect and disconnect the supply voltage from the first terminal. The control circuitry 1120 further includes startup logic 1122 which is configurable to control the disconnect switch 1150 during a power converter startup sequence to mitigate inrush and/or backflow currents. In an example operation, the startup logic 1122 is configured to open the disconnect switch 1150 to disconnect the supply voltage VHIGH from the first terminal 1112. The startup logic 1122 next operates the power switch circuitry 1116 using a startup voltage drawn from the load 1132 via the second terminal 1114 to generate a third voltage at the first terminal 1112. During the startup sequence, the internal voltage at terminal 1112 is raised to a target output voltage level. Next, the startup logic 1122 closes the disconnect switch 1150 to connect the supply voltage VHIGH to the first terminal 1112 when the third voltage is within a predetermined range of the supply voltage.

In some embodiments, the control circuitry 1120 is configurable to control the power switch circuitry 1116 to operate the power converter 1110 in a charge pump mode, receiving the voltage VLOW from the load 1132 at the second terminal 1114, and generating a high voltage output VHIGH at the first terminal 1112. As the power converter 1110 starts up, it takes time for the voltage at the first terminal 1112 to rise to the target output level. If VHIGH is being supplied to the first terminal 1112 from the voltage supply 1130 during this time, the difference between the rising voltage generated by the power converter 1110 and the supply voltage may generate inrush current. The startup logic 1122 is configured to control the disconnect switch 1150 to disconnect the supply voltage from the generated voltage (e.g., at terminal 1112) during the charge pump startup sequence.

In various embodiments, the disconnect switch 1150 may be implemented as an external switch (e.g., as illustrated or in another arrangement that disconnects the supply voltage from the terminal 1112), or as an internal switch disposed inside the power converter 1110 to disconnect the supply voltage from the target output voltage (e.g., arranged to disconnect the first terminal 1112 from the power switching circuitry 1116, implemented within the power switching circuitry 1116, or via another implementation).

In various embodiments, the startup logic 1122 may be implemented as analog and/or digital circuitry and/or logic implemented by controller or other logic device. In some embodiments, the startup logic 1122 is initiated as part of the startup and configuration logic for one or more operating modes of the power converter 1110. For example, the startup logic 1122 may be configured to operate the power converter 1110 in a boost mode during a startup sequence to generate the target voltage from the startup voltage supplied by the load 1132, where the target voltage is greater than the startup voltage.

In some embodiment, the startup logic 1122 comprises interlock circuitry couplable to the disconnect switch 1150, the voltage supply 1130, and the first terminal 1112. The interlock circuitry may, for example, be configured to sense the target voltage generated at the first terminal 1112 and the supply voltage. The interlock circuitry may be further configured to compare a difference between the supply voltage and the generated target voltage to a predetermined voltage range.

FIG. 12 is block diagram illustrating example circuitry 1200 including power switching circuitry 1210, a disconnect switch, and an example interlock circuit 1230, in accordance with one or more embodiments of the present disclosure. As illustrated, the power switching circuitry 1210 includes a plurality of switches configurable to selectively route a first voltage between a first terminal 1212 (e.g., between S3H and the disconnect switch 1220) and a second terminal 1214 (e.g., LX). As illustrated, the first terminal 1212 is electrically couplable to a supply voltage VSUPPLY and the second terminal 1214 is electrically couplable to a load such as a battery supplying a voltage VBATT.

Control circuitry (described with reference to FIGS. 1A-11) is configurable to generate a second voltage from the first voltage by selectively operating the power switch circuitry 1210 to charge and/or discharge one or more capacitors (e.g., CA, CB). In the illustrated embodiment, the power switching circuitry 1210 is controlled to implement a multi-level power converter. In some implementations, the power switching circuitry and control circuitry are configurable to operate as an M-level power converter, where M≥2. In some implementations, the control circuitry is configurable to operate the M-level power converter in a charge pump mode, a boost mode, and/or a buck mode to convert a first voltage received at the first terminal 1212 to a second voltage and/or a second voltage received at the second terminal 1214 to a third voltage.

The disconnect switch 1220 is coupled between the first terminal 1212 and the supply voltage VSUPPLY to selectively connect and disconnect the supply voltage from the switching circuitry. The disconnect switch 1220 is controlled by interlock circuitry 1230 to prevent voltage disparities at the high side input. The interlock circuitry 1230 is configured to execute startup logic to open the disconnect switch 1220 to disconnect the supply voltage VSUPPLY from the first terminal 1212. While the disconnect switch 1220 is open, the control circuitry executes startup logic to operate the power switch circuitry 1210 using a startup voltage VBATT drawn from the load via the second terminal 1214 to generate a target voltage at the first terminal 1212. The interlock circuitry 1230 is configured to close the disconnect switch 1220 to connect the supply voltage VSUPPLY to the first terminal 1212 when the target voltage is within a predetermined range of the first voltage.

During operation in a charge pump mode, the voltage VBATT supplied the battery (the actual load in this example) is used to startup the power converter, including the power switching circuitry 1210 and related circuitry including charging capacitors (e.g., CA, CB). The interlock circuit 1220 is configured to control the disconnect switch 1220 while the power converter is starting up in a charge pump mode (or other mode as appropriate) until the supply voltage VSUPPLY is close to the target voltage VHIGH. If the difference between the target voltage and the supply voltage is too high, then the power converter will experience inrush or backflow depending on whether the target voltage is above or below the supply voltage.

In an example operation, the power converter may be configured to receive VBATT as a startup voltage (e.g., 4 volts) and boost it to a target voltage level that is a multiple of the startup voltage (e.g., 8 volts in a 2× charge pump). During startup, the high side voltage level may be at or close to 0, and the output battery load provides the source energy to startup the power converter. In one example, VSUPPLY is expected to be delivered at 8 volts. The charge pump boosts the startup voltage to the target voltage of 8 volts and the interlock circuit 1230 monitors the supply voltage (VSUPPLY) and the target voltage (VHIGH) to determine when it is safe to connect the disconnect switch 1220.

In various embodiments, the input supply voltage and the charge pump ratio-metric voltage of the target output are configured to closely match. If the voltages are dramatically different, then it may cause large inrush or backflow currents. For example, if the battery voltage is 4V and the charge-pump generates a target output that is 3× the input (e.g., 12V), the supply voltage should be close to 12V in order to have a controlled current. The disconnect switch 1220 prevents voltage transfer until the supply voltage and target voltage are within an acceptable range from each other.

As discussed above, power converter 1110 may include an OVP and under voltage protection (UVP) and use the OVP and UVP as a point to stop startup during boot charging. If the OVP or UVP are far away from the target voltage, that means that the voltage on the capacitor is far away from target voltage. When a multi-level power converter is in a charge pump mode, this may cause a huge rush in or out current when the capacitor is trying to balance itself. The embodiments are directed to when, in a charge pump mode, the capacitor is charged to as close to the target voltage as possible. The voltage that the capacitor may be charged to be within the target voltage may be configurable and may be based on resistance of switches, budget for the highest current, and the impedance of the inductance on the inductor L1 of the multi-level charge pump. Accordingly, during boot charging, the OVP and UVP thresholds are brought as close to the target voltage as possible. In this way, when the boot charging completes, the voltage at the capacitor is as close to its target voltage. Additionally, after boot charging, the capacitor may balance until a target voltage is detected. In other embodiments, boot charging may pause when the power converter detects that the capacitor has not been charging and discharging for a predetermined time period.

In some instances, VHIGH may be too low. An example low VHIGH may be below 4 volts. In this case, there is no guarantee that the top switches above inductor L1, such as switches S1H, S2H, and S3H may switch on. In this case, power converter may run startup in an asynchronous mode. The asynchronous mode may occur in the boost mode. In the asynchronous mode, the top switches above the inductor L1 (switches S1H, S2H, and S3H) are not turned on. As a result, during startup, inductor L1 is charged to ground, so bottom switches below the inductor L1 (switches S1L, S2L, and S3L) are referenced to ground. Because switches S1L, S2L, and S3L are referenced to ground, there is no need to drive the gate drivers of switches S1L, S2L, and S3L or establish the floating rails of switches S1L, S2L, and S3L. Once the inductor L1 is charged to ground, the switches S1L, S2L, and S3L are released and the inductor L1 charges the output. Further, each one of the top switches S1H, S2H, and S3H has a parasitic body diode, that is in parallel with a main device. Diodes do not need to be controlled. Diodes can be turned on and off, and will turn on once the bottom switches S1L, S2L, and S3L will set up a voltage that would cause the diodes to turn on.

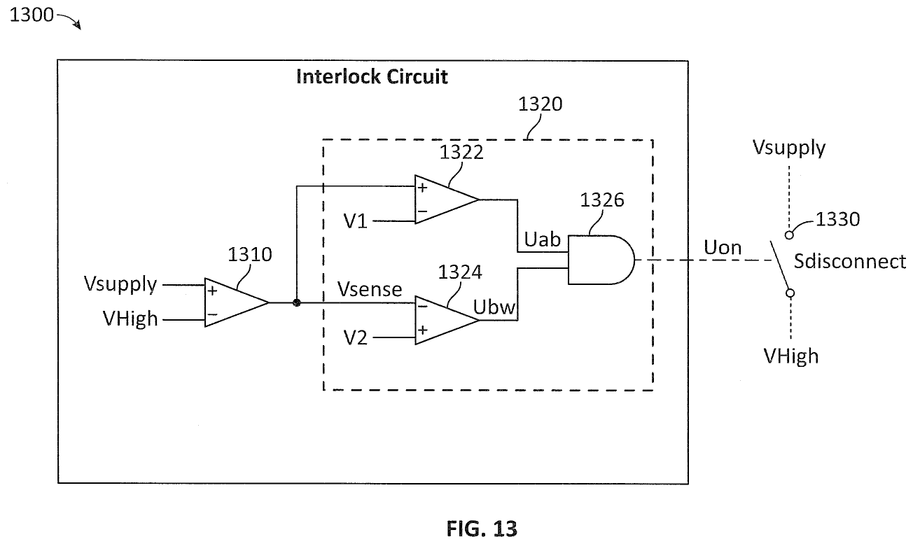

FIG. 13 is a functional block diagram illustrating example logic 1300 for operating an interlock circuit to control a disconnect switch 1330, in accordance with one or more embodiments of the present disclosure. In the illustrated embodiment, the interlock circuitry 1300 comprises an amplifier 1310 configured to receive the supply voltage VSUPPLY and the target voltage VHIGH and output a differential voltage VSENSE. The interlock circuitry 1300 further includes window comparator circuitry 1320 configured to determine if the differential voltage is within a predetermined range between a first reference voltage V1 and a second reference voltage V2. If the differential voltage is within the predetermined range (e.g., V1<VSENSE<V2), then a control signal UON closes the disconnect switch 1330 to connect the supply voltage VSUPPLY to the high side output VHIGH of the power converter.

As illustrated, the window comparator circuit 1320 includes a first comparator 1322 that receives a lower window reference V1 which is compared to the differential voltage VSENSE and outputs a logical output UAB indicating whether V1 is lower than VSENSE. The window comparator circuit 1320 further includes a second comparator 1324 that receives an upper window reference V2 which is compared to the differential voltage VSENSE and outputs a logic output UBW indicating whether V2 is higher than VSENS. The outputs UAB and UBW are fed to an AND gate 1326 and which sends a control signal UON to close the disconnect switch 1330 when both UAB and UBW evaluate to true.

In some embodiments, the values V1 and V2 are configurable and may be stored, for example, in registers and set for a particular mode and/or operational voltage levels. The size of the window may be based on a maximum allowable inrush current associated with safe operation of the power converter. For example, the selection of V1 and V2 may be based on the effective impedance of the charge pump (e.g., 100 milliohms) and an operational range of a desired current flow (e.g., in amps). Assuming design considerations indicate a safe operational range of 2 amps of current deviation, then the window may be set, for example, to allow 200 millivolts of error. In some embodiments, the window size (e.g., the values of V1 and V2) range is a configurable setting.

In some embodiments, the interlock circuit 1300 is configured to operate after completion of a startup sequence for the power converter. During startup, the interlock circuit 1300 may be configured to keep the disconnect switch 1330 open. In some embodiments, the interlock circuit 1300 may be configured to operate during the startup sequence. Although an interlock circuit may be implemented with circuit elements as illustrated in FIG. 13, it will be appreciated that the interlock circuit logical may be implemented through various combinations of analog and digital components, including a controller executing logical operations. For example, the interlock circuit may be implemented digitally (e.g., using ADC measurements on each side and disconnect switch).

In some embodiments, the interlock circuit is implemented on an integrated circuit and the sensed voltages of VSUPPLY and VHIGH may be passed to one or more host system components for further processing that may include, for example, interlock logic. The host system may pass a control signal back to the integrated circuit to control the disconnect switch 1330.

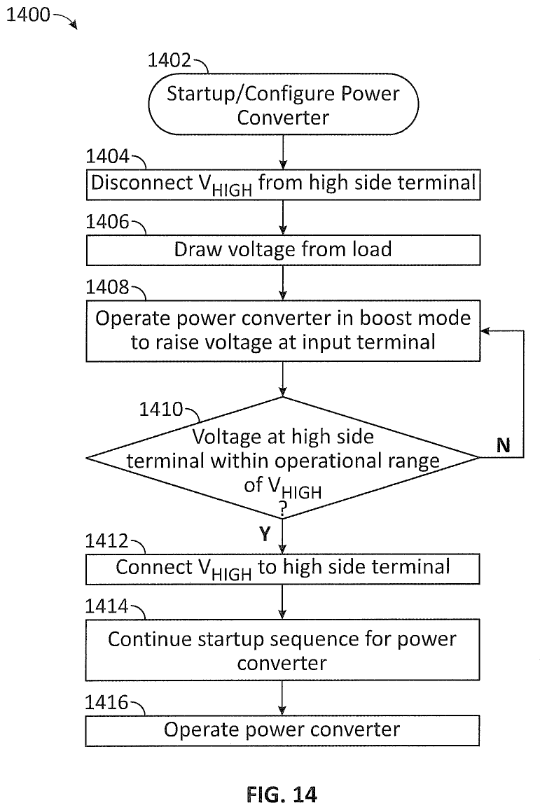

FIG. 14 illustrates an example startup sequence 1400 for a power converter, including operation of a disconnect switch to mitigate inrush and/or backflow, in accordance with one or more embodiments of the present disclosure. The startup sequence 1400 may be implemented by control circuitry including circuitry and/or one or more controllers as described herein with reference to FIGS. 1A-12.

In block 1402, the power converter is started up and configured for operation. In the illustrated embodiment, the startup mode of operation is charge pump mode that has a risk of inrush and/or backflow that is mitigated by use of a disconnect switch as described with reference to FIGS. 11-13 and 15. In various embodiments, the startup sequence 1400 may be used in other power converters and/or modes of operation, for example, where a disparity between a supply voltage and a target output voltage can cause inrush and/or backflow. In some embodiments, the power converter may be implemented as a multi-level power converter that is configurable to operate in a charge pump mode, a boost mode, and/or a buck mode to convert a first voltage to a second voltage at the second terminal and/or the second voltage to the first voltage.

In block 1404, the control circuitry controls a disconnect switch to disconnect a supply voltage from a first terminal of a circuit coupled to power switch circuitry of the power converter. The power switch circuitry is configured to selectively route a first voltage between the first terminal and a second terminal coupled to a load. In some embodiments, the circuitry described with reference to FIGS. 11-13 may be implemented. In other embodiments, other circuitry and/or logical processing may be used consistent with the teachings herein.

In block 1406, the power converter draws voltage from the load, which may be a battery of a host device. With the supply voltage disconnected from the power converter in block 1404, the power converter is configured to facilitate current flow from the inductor on the low side to the first terminal on the high side.

In block 1408, the control circuitry operates the power switch circuitry of the power converter using the startup voltage drawn from the load via the second terminal to generate a target voltage at the first terminal which is larger than the startup voltage. In various embodiments, the control circuitry is configured to operate in a voltage boost mode to generate a target voltage that is a multiple of the startup voltage received from the load.

In block 1410, the control circuitry, which may include interlock circuitry as described herein with reference to FIGS. 11-13 and 15, determines whether the voltage at the high side terminal is within an operational range of the supply voltage VHIGH. In some embodiments, the control circuitry senses the supply voltage and the generated target voltage and compares a difference between the supply voltage and the generate target voltage to a predetermined range.

In some embodiments, the control circuitry generates a differential voltage between the supply voltage and the generated target voltage using an amplifier and determines whether the differential voltage is within the predetermined range using window comparator circuitry. The window comparator circuitry may be configured to determine whether the differential voltage is between a first reference voltage and a second reference voltage.

If the two voltages are not within operational range, then the power convert continues to raise the target voltage at the high side terminal until the target voltage is within operational range of the supply voltage, thereby mitigating inrush and/or backflow currents after closing the disconnect switch to connect the supply voltage. In some embodiments, voltage disparities may be caused on the supply voltage side, which may be handled by the control circuitry and/or host device.

In block 1412, if the two voltages are within operational range, the supply voltage is connected to the high side terminal by closing the disconnect switch. In some embodiments, further startup operations may be performed as required (block 1414). In some embodiments, the disconnect switch is closed after completion of the startup sequence. In block 1416, the power converter is operated in the configured mode, such as charge pump mode in the illustrated embodiment.

In various embodiments, the disconnect switch is couplable between the supply voltage and the first terminal, wherein the disconnect switch is couplable between the first terminal and the power switch circuitry, and/or wherein the power switch circuitry comprises the disconnect switch.

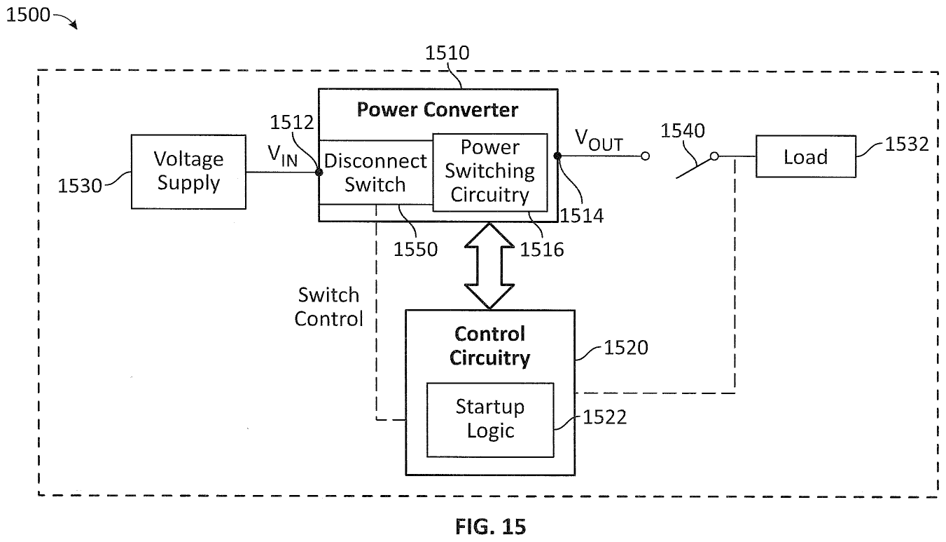

FIG. 15 is a high-level block diagram illustrating example inrush and/or backflow mitigation circuitry, in accordance with one or more embodiments of the present disclosure. A system 1500 includes a power converter 1510 including power switching circuitry 1516, and a disconnect switch 1550, and control circuitry 1520 including startup logic. The power converter 1510 is configured to receive a supply voltage VIN from a voltage supply 1530 at a first terminal 1512 and generate an output voltage V_{OUT} at a second terminal 1514 which is electrically coupled to a load 1532. The elements of FIG. 15 correspond to like elements previously described with respect to FIG. 13.

In the illustrated embodiment, the disconnect switch 1550 is located within the power converter circuitry, coupled directly or indirectly between the first terminal and the power switching circuitry 1516 a to isolate a target output voltage (e.g., generated in a boost mode from a startup voltage supplied by the load for output at the first terminal 1512) from the supply voltage V_{IN}. In some embodiments, the disconnect switch 1550 may be implemented in the power switching circuitry 1516.

In some embodiments, the load 1532 may be connected to one or more external switches 1540, which may be controlled along with the disconnect switch 1550 by the startup logic to mitigate inrush and backflow by connecting and/or disconnecting the load 1532. In some embodiments, if there is low risk of backflow, the one or more external switches 1540 may not be operated by the startup logic 1522 which can control inrush current using the disconnect switch 1550 as described herein.

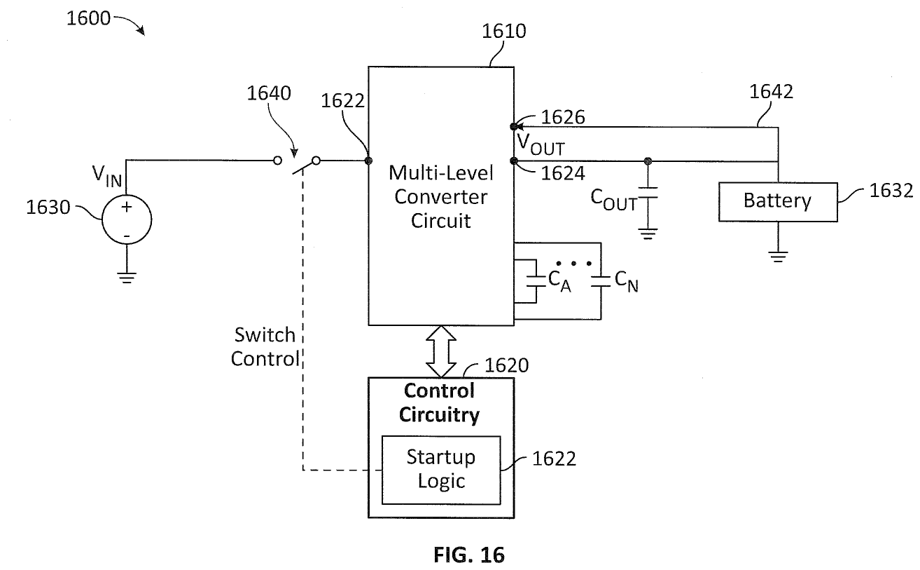

Referring to FIGS. 16-19, example startup procedures for improving operation of a multi-level converter circuit will now be described, in accordance with embodiments of the disclosure. FIG. 16 is a high-level block diagram of a system 1600 including a multi-level converter circuit 1610. In operation, the multi-level converter circuit 1610 is electrically coupled to one or more voltage supplies 1630, which may include a wired and/or wireless voltage supplies as discussed herein with respect to FIGS. 1A-14. The voltage supply 1630 may supply an input voltage VIN, which is received at a first terminal 1622 of the multi-level converter circuit 1610. In some embodiments, a disconnect switch 1640 (e.g., as described in FIGS. 11-14) may be provided allowing for inrush protection when starting in a charge pump mode, for example.

The multi-level converter circuit 1610 includes power switching circuitry which is controlled by control circuitry 1620 to route a voltage between the first terminal 1612 and a second terminal 1624, including charging and discharging one or more capacitors CA . . . CN, with the number of capacitors depending on the implementation. In some embodiments, the voltage supply VIN is converted to a lower voltage to generate an output voltage V_{OUT} to charge the battery 1632. One or more electrical paths, such as 1642, are provided coupling the battery 1632 to a terminal 1626 of the multi-level converter circuit to facilitate use of the battery voltage during one or more startup operations, in accordance with startup logic 1622.

In operation, the multi-level converter circuit 1610 may be implemented in a host system or device to charge a battery, for example, from a wired (e.g., USB) or wireless input. In another operation, the multi-level converter circuit 1610 may be configured to use the battery as a voltage source to provide voltage to a load such as a device connected to the host system through a wired (e.g., USB) or wireless connection. The embodiments of FIGS. 16-19 are described with reference to the latter operation, where the multi-level converter circuit 1610 is operated in a boost mode, using the battery as a voltage source.

As will be discussed further below, a startup sequence may include starting the multi-level converter circuit in a diode emulation/synchronous mode until VHIGH is above a threshold voltage. To gain control of the charging and discharging of the inductor while the voltage levels are low, the multi-level converter circuit may be configured in a 2-level operation, switching between VHIGH and GND (or another level lower than the battery voltage).

In some embodiments, a diode is added in a path between the battery voltage and VHIGH, allowing VHIGH to be charged to VLOW at startup. The battery voltage may be used to pre-charge one or more fly capacitors and gate driver bootstrap capacitors (also referred to herein as “boot capacitors”). The multi-level converter circuit may be operated as a boost converter.

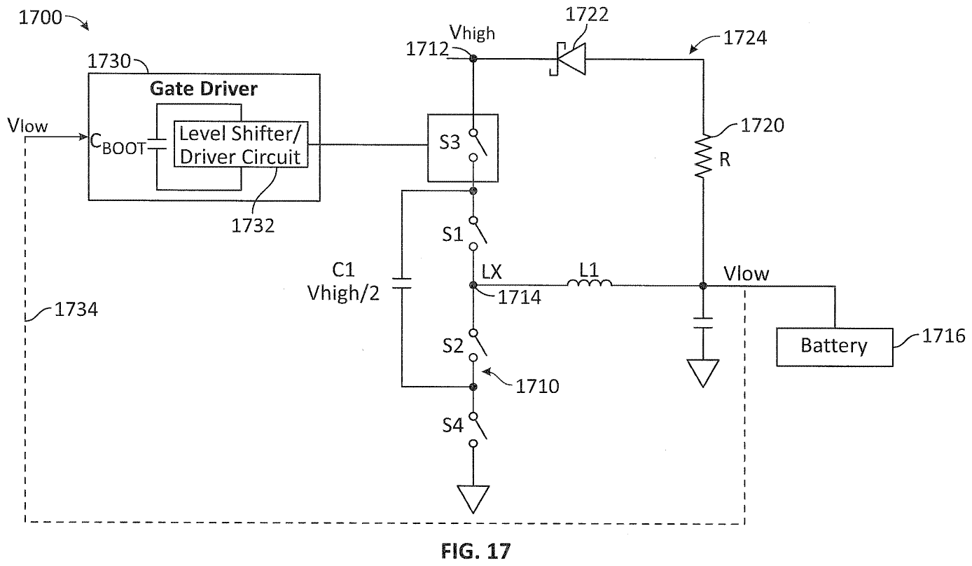

Referring to FIG. 17, example circuitry 1700 and processes for starting a multi-level power converter will now be described, in accordance with embodiments of the present disclosure. The circuitry 1700 includes power switching circuitry 1710 including a plurality of switches S1-S4 configurable to route a voltage between a first terminal 1712 and a second terminal 1714. The second terminal 1714 is electrically couplable to a battery 1716 through an inductor L1. In various embodiments, the power switching circuitry 1710 may be configured as any M-level circuitry, where M≥3, and include one or more circuitry, components, and/or logic as described herein with reference to FIGS. 1A-16.

The control circuitry (e.g., control circuitry 1620 of FIG. 16 or as otherwise described with reference to FIGS. 1A-16) is configurable to control the power switch circuitry 1710 to selectively charge and/or discharge one or more fly capacitors (e.g., C1 in the illustrated embodiment) to generate a boosted voltage (e.g., VHIGH) at the first terminal 1712 from a first voltage received at the second terminal 1714 (VLOW) from the battery 1720. Although 3-level power converter circuitry is illustrated with a single capacitor C1, it will be appreciated that a multi-level power converter circuitry having more levels and capacitors may be implemented.

In operation, the capacitor C1 of the 3-level power converter circuitry is charged to ½ of VHIGH, allowing the 3-level power converter to selectively deliver VHIGH, VHIGH/2, and GND. When configured to operate as a multi-level boost converter, the voltage VLOW from the battery 1720 is converted to the higher voltage VHIGH, which may be multiple of VLOW (e.g., 2*VLOW). Potential problems arise at startup, however, if VHIGH starts at 0 volts and VLOW is not strong enough to operate the multi-level boost converter to charge the capacitor C1 and bring VHIGH up to an operating level. In this scenario, the circuitry 1700 may lose control over the inductor L1 current.

As illustrated, the circuitry 1700 further includes an electrical path 1724 electrically coupling VLOW to VHIGH. The electrical path 1724 may include a resistor 1720 and diode 1722 connected in series between VLOW and VHIGH. In various embodiments, the electrical path 1724 may be implemented in an integrated circuit including the power switching circuitry 1710 and control circuitry 1520, implemented through circuitry outside of the integrated circuit (e.g., coupled to the integrated circuit via one or more terminals), or implemented in another system arrangement base, for example, on design considerations. The electrical path 1724 allows the voltage supplied by the battery 1716 to be applied to VHIGH through parallel resistive charging, raising VHIGH to approximately the voltage level of VLOW. In some embodiments, this approach will slow down reverse charging of the inductor L1 from the battery 1716, facilitating the startup sequence described herein. In the illustrated embodiment, the diode 1722 may be implemented as a Schottky diode.

In some embodiments, the electrical path 1724 remains active during operation to charge VHIGH to VLOW with a limiting current provided by the battery 1716. In some embodiments, a fault is detected if VHIGH drops lower than VLOW by a predetermined threshold and/or too much current is drawn through the inductor Li.

In an example startup sequence, VHIGH is charged with VLOW while the high-side switch S3 is “OFF” and conducting in a non-synchronous mode. For example, the switches S1-S4 may be implemented as low voltage FETs/MOSFETs, providing a current path through the switch's body diode and additional voltage at VHIGH (e.g., an extra 700 millivolts in an example implementation). During this sequence, the inductor L1 is charged and VHIGH is ramped up to a voltage level that is close to VLOW, allowing limited operation of the circuitry 1700. One or more fly capacitors (e.g., capacitor C1 of the illustrated 3-level converter) of the multi-level power converter may be pre-charged using the voltage received at the second terminal 1714 from the inductor L1.

The state of each of the plurality of switches, S1-S4, is controlled by a corresponding gate driver 1730. In the illustrated embodiment, the gate driver 1730 includes a boot capacitor, CBOOT, which provides voltage to drive a level shifter/driver circuit 1732 electrically coupled to the corresponding switch for operating the switch. A second electrical path 1734 is added to electrically couple the boot capacitor, CBOOT, to VLOW. During a startup sequence, the boot capacitor, CBOOT, may be pre-charged using VLOW via the second electrical path 1734. In some embodiments, the gate drivers 1730 may be selectively pre-charged and activated in a startup sequence. After pre-charging the capacitor C1, the control circuitry may operate the circuitry 1700 as a multi-level power converter in a boost mode.

In some embodiments, after pre-charging a first gate driver 1730, the control circuitry may start operation as a two-level multi-level power converter and then transition to additional levels of operation. For example, in an M-level power converter, where M≥3, each transition from an operating level, N, to a next level, N+1, may include pre-charging an N+1-level fly capacitor. The transition may further include pre-charging, for each N+1-level switch, the boot capacitor of the corresponding gate driver. Transitioning to an N+1-level boost converter operation may be initiated when one or more pre-charging thresholds are exceeded. For example, control circuitry may monitor a voltage level of the N+1 level fly capacitor (e.g., through a voltage sensing circuit, such as described herein with respect to FIG. 8C) to determine when the capacitor is pre-charged to a level exceeding a pre-charging threshold. In some embodiments, the pre-charging threshold may be based on a ratio of VHIGH.

In some embodiments, the capacitor is being charged, e.g., during boot charging, energy is also added to an inductor L1. When the inductor is being discharged, such as during a pulse, the energy may move the voltage on capacitor CL. In some instances, there may be monitoring circuitry (not shown) on the capacitor C1 that determines when the capacitor C1 voltage moves too far (e.g., above or below a predefined threshold depending on charging or discharging the capacitor C1) from the target voltage. When the monitoring circuitry determines that the voltage on capacitor C1 moves too far from the target voltage, the startup sequence is paused until the current source(s) bring the voltage on capacitor C1 back to the target voltage. The pause may be a feedback pause until the monitoring circuitry determines that the voltage on capacitor C1 reaches the target voltage. Alternatively, the pause may be a timing pause for a predetermined time period. In yet another embodiment, the voltage on capacitor C1 may be controlled by giving lower frequency clock to boot charging. In this way, the charging pulses are shorter and are spaced further apart, thus giving inductor less time to discharge and move the voltage on capacitor C1 away from the target voltage.

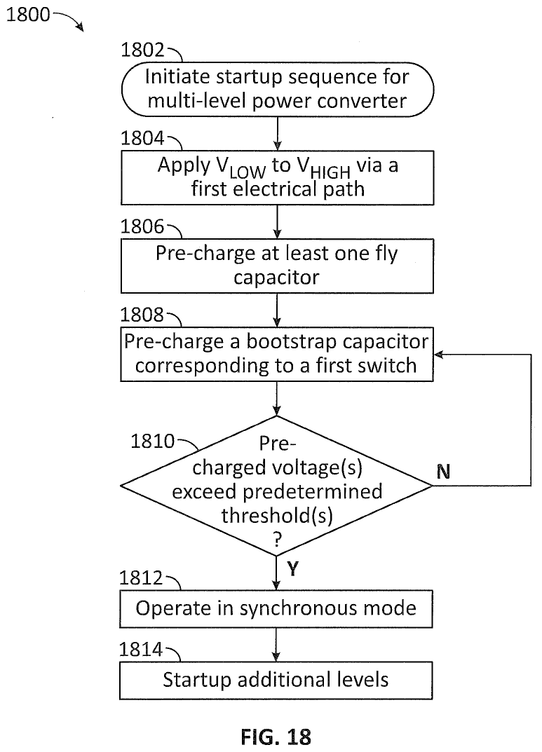

Referring to FIG. 18, an example startup process 1800 for a multi-level power converter using the circuitry of FIG. 17 will now be described, in accordance with embodiments of the present disclosure. In various embodiments, the startup process 1800 may be executed by any control circuitry or controller configurable to operate a multi-level power converter, such as control circuitry 1620 of FIG. 16 and/or as otherwise described herein with reference to FIGS. 1A-17. The multi-level power converter may be any multi-level power converter, such as described herein with reference to FIGS. 1A-17.

In operation, a multi-level power converter will operate to charge the fly capacitors to a ratio of the input voltage (VHIGH). At startup, however, the input voltage is not defined and the controller may not be powered up for normal operation.

In block 1802, the control circuitry initiates a startup sequence for a multi-level power converter. In block 1804, a voltage VLOW drawn from a battery is applied to VHIGH via a first electrical path that couples the low-side voltage of the multi-level power converter to the high-side voltage.

In block 1806, at least one fly capacitor of the multi-level power converter is pre-charged using the voltage VLOW received at a low-side terminal of the multi-level power converter.

In block 1808, the voltage VLOW is used to pre-charge a bootstrap capacitor of a first power switch of the multi-level power converter. The voltage VLOW is electrically coupled to the bootstrap capacitor through a second electrical path configurable to electrically couple the VLOW to a first gate driver for the first switch.

In block 1810, the control circuitry monitors one or more pre-charge voltage levels, which may include the voltage level at VHIGH, the voltage level of the pre-charged fly capacitor, and the voltage level of the pre-charged bootstrap capacitor. The monitored pre-charge voltage levels are compared against corresponding predetermined threshold values. In some embodiments, pre-charging is performed until the monitored pre-charge voltage levels exceeds the corresponding predetermined threshold values. In some embodiments, the fly capacitor is pre-charged to at least a threshold level based on a ratio of a target voltage for VHIGH.

In block 1812, the control circuitry operates the pre-charged circuitry of the multi-level power converter in a synchronous mode. In various embodiments, the startup process may configure the multi-level power converter to start operation as a 2-level power converter, a 3-level power converter, or an M-level power converter, and transition to additional levels of operation until fully operational. In block 1814, the control circuitry continues the startup process by pre-charging and transitioning to additional levels of the multi-level power converter. The multi-level power converter may be operated as boost converter, receiving the voltage VLOW at a low-side terminal and generating a boosted voltage VHIGH at the high-side terminal. The transition between levels may include pausing the startup sequence to allow the capacitors to rebalance at a current level of operation before transitioning to a next level.

In some embodiments, for example, the control circuitry may sequentially transition a 3-level power converter to an M-level power converter, where M≥4. Each transition from a current level, N, to a next level N+1, may include pre-charging an N+1-level fly capacitor of the one or more fly capacitors, pre-charging, for each N+1-level switch, a corresponding gate driver, and transitioning to N+1-level power converter operation when one or more pre-charging thresholds are exceeded.

In various embodiments, the startup sequence generally includes raising VHIGH using VLOW via a first electrical path, pre-charging the fly capacitors, pre-charging bootstrap capacitors corresponding to the power switches, and running the multi-level power converter in a boost mode.

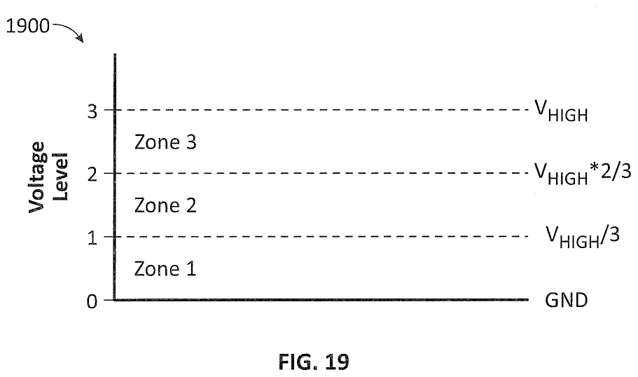

Additional considerations for starting and/or operating a multi-level power converter will now be described with reference to FIG. 19, which illustrates operational voltage levels of a example 4-level multi-level power converter, in accordance with embodiments of the present disclosure. As illustrated, a 4-level multi-level power converter may generate voltages between VHIGH and GND, including a voltage of a first capacitor VHIGH*⅔ and a voltage of a second capacitor VHIGH/3. For purpose of discussion, the multi-level power converter may operate in three zones: Zone 1 (between GND and VHIGH/3), Zone 2 (between VHIGH/3 and VHIGH*⅔), and Zone 3 (between VHIGH*⅔ and VHIGH).

During startup, VHIGH is first charged to VLOW before the fly capacitors are charged. In this state, the multi-level power converter may be operating in Zone 3, as there is very low voltage across the fly capacitors and the power switches aren't fully operational at this state of the startup sequence.

In an example operation, consider a battery generating 3-4 volts where the operating voltage of VHIGH is expected to be in a higher range, such as 8-18V. If VHIGH is 8 volts, then an output voltage may be regulated in Zone 2, for example, at 4V (half of VHIGH). During operation with VHIGH at 15 volts, then Zone 2 will include voltages between 5-10 volts, with the battery generating a voltage at a level in Zone 1. At startup, capacitor voltages will initially be very small or zero. If VHIGH is charged by VLOW to 4 volts, for example, then the capacitors will be ratiometrically charged to approximately 2.7 volts, and 1.3 volts, respectively. At this stage of the startup sequence, however, the circuit may be operating in ZONE 3, making 4-level operation difficult at such a low voltage. In some embodiments, the multi-level power converter is initially operated in a 2-level operation (or 3-level), while keeping the capacitors in ratio to VHIGH. If the output is 3 volts, for example, the inductor may be charged down to GND, and when released go to VHIGH in a 2-level operation. When operating in Zone 3 during startup, if the PWM signal indicates to go low the operation skips VHIGH*⅔ (which barely charges the inductor at that level) and goes lower, such as to GND or VHIGH/3. When operation is in Zone 2, there may be sufficient voltage to control the inductor in a 3-level operation.

As previously discussed, in various embodiments a multi-level power converter is configurable to operate in a boost mode during startup using the system battery as the input supply. During startup, the fly capacitors are charged to a ratiometric voltage of VHIGH. The multi-level power converter may be configurable to enter a charge pump mode after the fly capacitors are charged to an operational level.

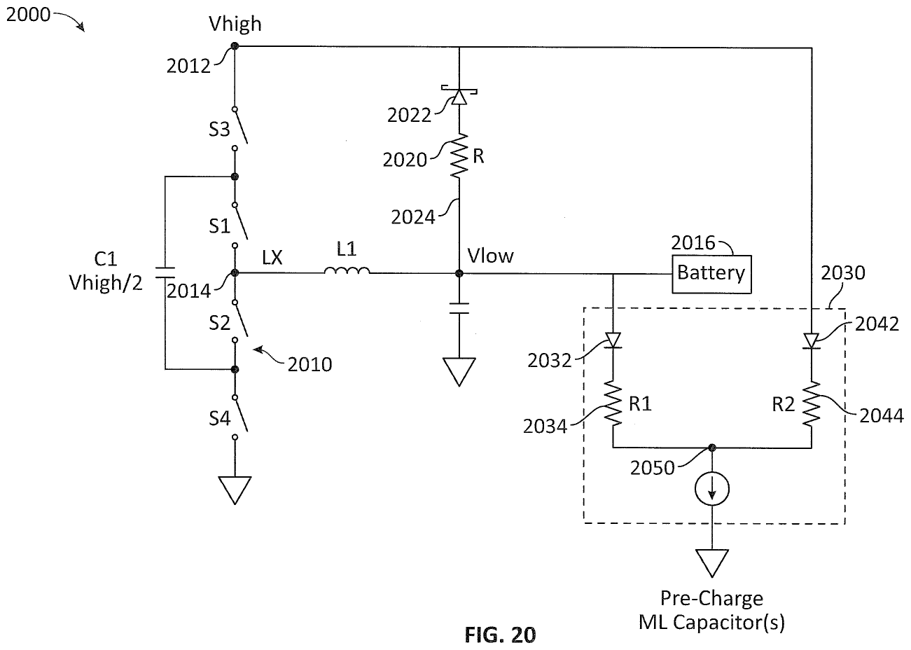

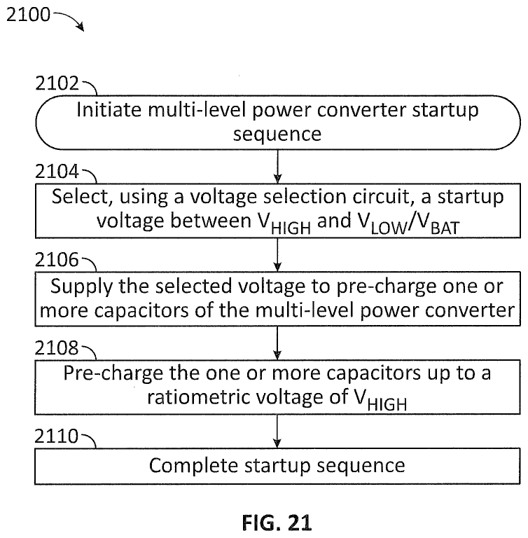

Referring back to FIG. 17, the fly capacitors CA . . . CN are uncharged at the initiation of the startup sequence. The multi-level converter circuit 1610 may be configured to operate in a boost mode as a charge pump using voltage from the battery. In some embodiments, the voltage at VHIGH may be higher than the low-side voltage from the battery, VBATT, and may provide a better voltage source for powering the startup circuitry. FIGS. 20-21 illustrate circuitry and a method of operation to optimize the voltage used during a startup sequence.

Referring to FIG. 20, example circuitry 2000 and processes for optimizing startup voltage of a multi-level power converter will now be described, in accordance with embodiments of the present disclosure. The circuitry 2000 includes power switching circuitry 2010 including a plurality of switches S1-S4 configurable to route a voltage between a first terminal 2012 and a second terminal 2014. The second terminal 2014 is electrically couplable to a battery 2016 through an inductor L1. In various embodiments, the power switching circuitry 2010 may be configured as any M-level circuitry, where M≥3, and include one or more circuits, components, and/or logic as further described herein with reference to FIGS. 1A-19.

The multi-level control circuitry (e.g., control circuitry 1620 of FIG. 16 or as otherwise described with reference to FIGS. 1A-16) is configurable to control the power switch circuitry 2010 to selectively charge and/or discharge one or more fly capacitors (e.g., C1 in the illustrated embodiment) to generate a boosted voltage (e.g., VHIGH) at the first terminal 2012 from a voltage received at the second terminal 2014 (e.g., VLOW) from the battery 2016. Although 3-level power converter circuitry is illustrated with a single capacitor C1, it will be appreciated that a multi-level power converter circuitry having more levels and capacitors may be implemented.

As illustrated, the circuitry 2000 may optionally include an electrical path 2024 electrically coupling VLOW to VHIGH. The electrical path 2024 may include a resistor 2020 and diode 2022 connected in series between VLOW and VHIGH. Further details of the electrical path 2024, including operation and related startup processes, have been previously described with reference to FIGS. 16-19.

The circuitry further includes a voltage selection circuit 2030 configured to select a startup voltage source between VHIGH and VLOW. In various configurations, the voltage at VHIGH may be, for example, an input voltage VIN supplied by an external voltage source, zero, approximately VLOW when the optional electrical path 2024 is provided, or a high-side output voltage generated by the multi-level power converter. In various configurations, the voltage at VLOW may be, for example, a voltage supplied by the battery 2016, or a low-side voltage generated by the multi-level power converter.

In the illustrated embodiment, the voltage selection circuit 2030 is implemented as a diode ORing circuit including first path electrically coupled to VLOW including a diode 2032 and a resistor 2034 connected in series, and a second path electrically coupled to VHIGH and arranged in parallel to the first path, including a diode 2042 and a resistor 2044 connected in series. The first path and second path are electrically coupled to an output node 2050. In operation, the voltage selection circuit 2030 receives VLOW and HIGH and selects the higher voltage for output. The selected output voltage may then be used during a startup sequence to pre-charge one or more capacitors of the multi-level power converter. Although a diode ORing circuit is illustrated, it will be appreciated that other voltage select circuits may be used to select and/or combine the two voltages to generate a selected voltage.

At initiation of a startup sequence, the one or more fly capacitors of the multi-level power converter are uncharged and/or charged at a voltage level below a ratiometric voltage of VHIGH. The selected voltage may be used to pre-charge the one or more fly capacitors up to a ratiometric voltage of VHIGH during the startup sequence. The multi-level control circuitry may be configured to monitor the capacitor voltages and discontinue pre-charging using the selected voltage after a ratiometric voltage is reached.

In various embodiments, the selected voltage may be used to charge a plurality of capacitors, such as a plurality of fly capacitors of an M-level power converter, for M≥3. During operation, the multi-level control circuitry may control the power switch circuitry 2010 to selectively charge and/or discharge a plurality of fly capacitors, each fly capacitor having a corresponding ratiometric voltage of the first voltage. Each of the plurality of fly capacitors may be electrically couplable to, and pre-charged by, the selected voltage during the startup sequence.

FIG. 21 illustrates an example process 2100 for selecting an optimal startup voltage during startup sequence, in accordance with embodiments of the present disclosure. In various embodiments, the startup process 2100 may be executed by any control circuitry or controller configurable to operate a multi-level power converter, such as control circuitry 1620 of FIG. 16 and/or as otherwise described herein with reference to FIGS. 1A-20. The multi-level power converter may be any multi-level power converter, such as described herein with reference to FIGS. 1A-20.

At block 2102, the multi-level control circuitry initiates a startup sequence for a multi-level power converter. The multi-level power converter may include power switch circuitry configurable to route a voltage between a first terminal and a second terminal to selectively charge and/or discharge one or more capacitors (e.g., a fly capacitor).

At block 2104, a voltage selection circuit is used the select a startup voltage between VHIGH and VLOW/VBAT. The voltage selection circuit is electrically coupled to the first terminal to receive the voltage at VHIGH and the second terminal to receive a second voltage which may include the low side voltage or the battery voltage VBAT. In various embodiments, the multi-level power converter may be implemented in a mobile device including a battery that is charged by the multi-level power converter. In operation the multi-level power converter may not know if the first voltage will be provided (e.g., whether the mobile device is plugged in to a voltage source), but the second voltage will typically be available at startup through the battery. In some embodiments, the multi-level power converter is configured to operate in a boost mode at startup using voltage drawn from the battery. In some embodiments, the voltage selection circuit is a diode ORing circuit, for example, as described in FIG. 20.

At block 2106, the selected voltage is used to pre-charge one or more capacitors of the multi-level converter, which may include one or more fly capacitors. In some embodiments, at startup the one or more fly capacitors are uncharged and/or charged at a voltage level below a ratiometric voltage of VHIGH.

At block 2108, the multi-level control circuitry pre-charges the one or more capacitors during the startup sequence to a ratiometric voltage of VHIGH. In some embodiments, the capacitors may be pre-charged in a sequence starting from a first level and transitioning to additional levels as previously discussed with respect to FIGS. 16-19. For example, the power switch circuitry may be operated as an M-level power converter, for M≥3, by selectively charging and/or discharging a plurality of fly capacitors, each fly capacitor having a corresponding ratiometric voltage of the first voltage. Each of the plurality of fly capacitors is electrically couplable to, and configurable to be pre-charged by, the selected voltage during the startup sequence.

In an example startup sequence, each transition from a current level, N, to a next level N+1, may include pre-charging an N+1-level fly capacitor of the one or more fly capacitors using the selected voltage, pre-charging, for each N+1-level switch, the corresponding boot capacitor; and transitioning to N+1-level boost converter operation when one or more pre-charging thresholds are exceeded.

In block 2110, after the capacitors are pre-charged, the startup sequence continues until completion. The multi-level power converter is then operational and may be used, for example, to supply a voltage to a device (e.g., a peripheral device) through a wired and/or wireless connection.

Further aspects of the present disclosure include the following:
Aspect 1 includes a system comprising: power switch circuitry comprising a plurality of switches configurable to route a voltage between a first terminal and a second terminal, wherein the second terminal is electrically couplable to receive a first voltage from a load; control circuitry configurable to control the power switch circuitry to selectively charge and/or discharge one or more fly capacitors to generate a boosted voltage at the first terminal from the first voltage received at the second terminal; and a first electrical path configurable to electrically couple the first terminal and the first voltage; wherein the plurality of switches comprises a first switch and a first gate driver for operating the first switch, the first gate driver electrically couplable to the first voltage through a second electrical path; wherein the control circuitry is further configurable to operate a startup sequence comprising: applying the first voltage to the first terminal via the first electrical path; pre-charging, by selectively controlling the power switch circuitry, a first fly capacitor of the one or more fly capacitors using the first voltage received at the second terminal; and pre-charging the first gate driver using the first voltage via the second electrical path.
Aspect 2 includes the system of aspect 1, wherein the startup sequence further comprises, after the control circuitry pre-charges the first gate driver, operating the control circuitry as a two-level multi-level power converter.
Aspect 3 includes the system of any of aspects 1-2, wherein the startup sequence further comprises, sequentially transitioning two-level multi-level power converter operation to an M-level power converter operation, where M≥3; and wherein each transition from a current level, N, to a next level, N+1, comprises: pre-charging an N+1-level fly capacitor of the one or more fly capacitors; pre-charging, for each N+1-level switch, the corresponding gate driver; and transitioning to N+1-level boost converter operation when one or more pre-charging thresholds are exceeded.
Aspect 4 includes the system of any of aspects 1-3, wherein the first switch comprises a field effect transistor that forms a body diode configurable to facilitate current flow through the first switch when the first switch is in an OFF state.
Aspect 5 includes the system of any of aspects 1-4, wherein the first electrical path comprises a resistor and a diode connected in series.
Aspect 6 includes the system of any of aspects 1-5, wherein the diode is a Schottky diode.
Aspect 7 includes the system of any of aspects 1-6, wherein the load comprises a battery; and wherein the boosted voltage is configurable to be supplied to a peripheral device electrically couplable to the system.
Aspect 8 includes the system of any of aspects 1-7, wherein the first fly capacitor is pre-charged to a level exceeding a pre-charging threshold based on a ratio of the boosted voltage.
Aspect 9 includes a method comprising: initiating, using control circuitry, a startup sequence for circuitry comprising power switch circuitry configurable to route a voltage between a first terminal and a second terminal, wherein the second terminal is electrically couplable to receive a first voltage from a load; applying, via a first electrical path electrically coupling the first terminal and the first voltage, the first voltage to the first terminal; pre-charging a first fly capacitor of the one or more fly capacitors using the first voltage received at the second terminal; and pre-charging a first gate driver corresponding to a first switch of the plurality of switches through a second electrical path configurable to electrically couple the first voltage and the first gate driver, wherein the first gate driver controls operation of the first switch.
Aspect 10 include the method of aspect 9, further comprising, after pre-charging the first gate driver, operating the circuitry as a 2-level power converter.
Aspect 11 includes the method of any of aspects 9-10, further comprising, sequentially transitioning the 2-level power converter to an M-level power converter, where M≥3; and wherein each transition from a current level, N, to a next level N+1, comprises: pre-charging an N+1-level fly capacitor of the one or more fly capacitors; pre-charging, for each N+1-level switch, a corresponding gate driver; and transitioning to N+1-level power converter operation when one or more pre-charging thresholds are exceeded.
Aspect 12 includes the method of any of aspects 9-11, wherein the first switch comprises a field effect transistor that forms a body diode configurable to facilitate current flow through the first switch when the first switch is in an OFF state.
Aspect 13 includes the method of any of aspects 9-12, wherein the first electrical path comprises a resistor and a diode connected in series.
Aspect 14 includes the method of any of aspects 9-13, wherein the load comprises a battery, the method further comprising: generating, by the control circuitry operating the power switch circuitry, a boosted voltage from the first voltage; and supplying the boosted voltage to a peripheral device.
Aspect 15 includes the method of any of aspects 9-14, wherein pre-charging, using the first voltage, the first fly capacitor of the one or more fly capacitors comprises pre-charging the first fly capacitor to at least a threshold level based on a ratio of a target voltage.
Aspect 16 includes a system comprising: a multi-level power converter comprising a plurality of switches and a corresponding plurality of boot capacitors, each of the plurality of boot capacitors configurable to provide a control signal to the corresponding switch; control circuitry configurable to control the plurality of switches to selectively charge and discharge one or more fly capacitors using a first voltage received at a second terminal to generate a boosted voltage at a first terminal; wherein the multi-level power converter is configurable to operate a startup sequence comprising: applying the first voltage to the first terminal on a first electrical path; pre-charging a first fly capacitor of the one or more fly capacitors using the first voltage to a level exceeding a pre-charging threshold based on a ratio of the boosted voltage; and pre-charging a first boot capacitor corresponding to a first switch using the first voltage.
Aspect 17 includes the system of aspect 16, wherein the startup sequence further comprises, after pre-charging the first boot capacitor, operating the multi-level power converter as a 2-level power converter.
Aspect 18 includes the system of any of aspects 16-17, wherein the startup sequence further comprises, sequentially transitioning the multi-level power converter to an M-level power converter, where M≥3; and wherein each transition from a current level, N, to a next level N+1, comprises: pre-charging an N+1-level fly capacitor of the one or more fly capacitors; pre-charging, for each N+1-level switch, the corresponding boot capacitor; and transitioning to N+1-level power converter operation if one or more pre-charging thresholds are exceeded.
Aspect 19 includes the system of any of aspects 16-18, wherein the first electrical path comprises a resistor and a diode connected in series.
Aspect 20 includes the system of any of aspects 16-19 wherein the system further comprises: a battery configurable to be electrically couplable to the second terminal to generate the first voltage; and circuitry configurable supply the boosted voltage to a peripheral device electrically couplable to the multi-level power converter.

Further aspects of the present disclosure include the following:
Aspect 1 includes an integrated circuit comprising: power switch circuitry configurable to selectively route a first voltage between a first terminal and a second terminal, wherein the first terminal is electrically couplable to a supply voltage and the second terminal is electrically couplable to a load; control circuitry configurable to generate a second voltage from the first voltage by selectively operating the power switch circuitry to charge and/or discharge one or more capacitors; a disconnect switch configurable to selectively connect and disconnect the supply voltage; and startup logic configurable to: open the disconnect switch to disconnect the supply voltage from the first terminal; operate the power switch circuitry using a startup voltage drawn from the load via the second terminal to generate a third voltage at the first terminal; and close the disconnect switch to connect the supply voltage to the first terminal when the third voltage is within a predetermined range of the first voltage.
Aspect 2 includes the integrated circuit of aspect 1, wherein the control circuitry is configurable to operate the power switch circuitry as an M-level power converter, where M≥2, configurable to operate in a charge pump mode, a boost mode, and/or a buck mode to convert the first voltage to the second voltage and/or the second voltage to the first voltage.
Aspect 3 includes the integrated circuit of any of aspects 1-2, wherein the third voltage is greater than the startup voltage; and wherein the control circuitry is further configured to control the power switch circuitry to operate as a power converter in a boost mode during startup operations to generate the third voltage from the startup voltage.
Aspect 4 include the integrated circuit of any of aspects 1-3, wherein the startup logic is further configured to sense the first voltage and the third voltage and compare a difference between the first voltage and the third voltage to the predetermined range.
Aspect 5 includes the integrated circuit of any of aspects 1-4, wherein the startup logic comprises interlock circuitry electrically couplable to the supply voltage, the disconnect switch, and the first terminal.
Aspect 6 includes the integrated circuit of any of aspects 1-5, wherein the interlock circuitry comprises: an amplifier configured to receive the first voltage and the third voltage and output a differential voltage; and window comparator circuitry configured to determine if the differential voltage is within the predetermined range between a first reference voltage and a second reference voltage.
Aspect 7 includes the integrated circuit of any of aspects 1-6, wherein the startup logic is further configured to generate the third voltage to approximate the first voltage at the first terminal, thereby mitigating inrush and/or backflow currents in the power switch circuitry during startup.
Aspect 8 includes the integrated circuit of any of aspects 1-7, wherein the disconnect switch is couplable between the supply voltage and the first terminal, wherein the disconnect switch is couplable between the first terminal and the power switch circuitry, and/or wherein the power switch circuitry comprises the disconnect switch.
Aspect 9 includes the integrated circuit of any of aspects 1-8, wherein the load is couplable to the second terminal through one or more external switches; and wherein the startup logic is further configured to operate the one or more external switches and the disconnect switch to mitigate current backflow.
Aspect 10 includes a system comprising the integrated circuit of any of aspects 1-9.
Aspect 11 includes a method comprising: opening a disconnect switch to disconnect a supply voltage from a first terminal of a circuit coupled to power switch circuitry, the power switch circuitry configured to selectively route a first voltage between the first terminal and a second terminal coupled to a load; operating the power switch circuitry using a startup voltage drawn from the load via the second terminal to generate a third voltage at the first terminal; and closing the disconnect switch to connect the supply voltage to the first terminal when the third voltage is within a predetermined range of the first voltage.
Aspect 12 includes the method of aspect 11, further comprising: operating the power switch circuitry as a multi-level power converter in a charge pump mode, a boost mode, and/or a buck mode to convert the first voltage to a second voltage at the second terminal and/or the second voltage to the first voltage.
Aspect 13 includes the method of any of aspects 11-12, wherein operating the power switch circuitry using the startup voltage further comprises: operating the power switch circuitry as a multi-level power converter in a boost mode to generate the third voltage from the startup voltage, wherein the third voltage is greater than the startup voltage.
Aspect 14 includes the method of any of aspects 11-13, further comprising: sensing the first voltage and the third voltage; comparing a difference between the first voltage and the third voltage to the predetermined range by: generating a differential voltage between the first voltage and the third voltage using an amplifier; and determining whether the differential voltage is within the predetermined range using window comparator circuitry configured to determine whether the differential voltage is between a first reference voltage and a second reference voltage.
Aspect 15 includes the method of any of aspects 11-14, further comprising raising the third voltage at the first terminal to approximate the first voltage, thereby mitigating inrush and/or backflow currents after closing the disconnect switch to connect the supply voltage to the first terminal.
Aspect 16 includes a system comprising: a multi-level power converter comprising: power switch circuitry configurable to selectively route a first voltage between a first terminal and a second terminal, wherein the first terminal is electrically couplable to a supply voltage and the second terminal is electrically couplable to a battery; control circuitry configurable to selectively operate the power switch circuitry to generate a second voltage from the first voltage by charging and/or discharging one or more capacitors; and a disconnect switch configurable to selectively connect and disconnect the supply voltage; and wherein the multi-level power converter further comprises startup logic configurable to: open the disconnect switch to disconnect the supply voltage from the first terminal; operate the power switch circuitry using a startup voltage drawn from the battery via the second terminal to generate a third voltage at the first terminal; and close the disconnect switch to connect the supply voltage to the first terminal when the third voltage is within a predetermined range of the first voltage.
Aspect 17 includes the system of aspect 16, wherein the third voltage is greater than the startup voltage; and wherein the startup logic is further configured to operate the multi-level power converter in a boost mode to generate the third voltage from the startup voltage to approximate the first voltage, thereby mitigating inrush and/or backflow currents after closing the disconnect switch to connect the supply voltage to the first terminal.
Aspect 18 includes the system of any of aspects 16-17, wherein the startup logic comprises interlock circuitry couplable to the disconnect switch, the supply voltage, and the first terminal; and wherein the interlock circuitry is configured to: sense the first voltage and the third voltage; and compare a difference between the first voltage and the third voltage to the predetermined range.
Aspect 19 includes the system of any of aspects 16-18, wherein the disconnect switch is couplable between the supply voltage and the first terminal, wherein the disconnect switch is coupled between the first terminal and the power switch circuitry, and/or wherein the power switch circuitry comprises the disconnect switch.
Aspect 20 includes the system of any of aspects 16-19, wherein the system comprises a mobile device comprising the multi-level power converter, the disconnect switch, and the battery; wherein the supply voltage is a wired and/or wireless supply voltage; wherein the battery is couplable to the second terminal through one or more external switches; and wherein the startup logic is further configured to operate the one or more external switches and the disconnect switch to mitigate current backflow.

Further aspects of the present disclosure include the following:
Aspect 1 includes an integrated circuit comprising: power switch circuitry configurable to selectively route a voltage between a first terminal and a second terminal; multi-level control circuitry configurable to receive a first voltage at the first terminal and generate, by selectively charging and/or discharging a first fly capacitor, a second voltage at the second terminal; and a circuit electrically couplable to the first terminal to receive the first voltage and the second terminal to receive the second voltage, the circuit configurable to select one or more of the first voltage and the second voltage as a selected voltage to pre-charge the first fly capacitor during a startup sequence.
Aspect 2 includes the integrated circuit aspect 1, wherein the multi-level control circuitry is configurable to operate in a boost mode during startup and uses a battery couplable to the second terminal to supply the second voltage.
Aspect 3 includes the integrated circuit of any of aspects 1-2, wherein at initiation of the startup sequence, the first fly capacitor is uncharged and/or charged at a voltage level below a ratiometric voltage of the first voltage.
Aspect 4 includes the integrated circuit of any of aspects 1-3, wherein the first fly capacitor is pre-charged to a ratiometric voltage of the first voltage during the startup sequence.
Aspect 5 includes the integrated circuit of any of aspects 1-4, wherein the multi-level control circuitry is configurable to operate the power switch circuitry as an M-level power converter, for M≥3, to selectively charge and/or discharge a plurality of fly capacitors, each fly capacitor having a corresponding ratiometric voltage of the first voltage; and wherein each of the plurality of fly capacitors is electrically couplable to, and pre-charged by, the selected voltage during the startup sequence.
Aspect 6 includes the integrated circuit of any of aspects 1-5, wherein the circuit is a diode ORing circuit.
Aspect 7 includes the integrated circuit of any of aspects 1-6, wherein the circuit comprises: a first electrical path comprising a first diode and a first resistor connected in series between the first terminal and an output node of the circuit; and a second electrical path comprising a second diode and a second resistor connected in series between the second terminal and the output node of the circuit.
Aspect 8 includes a method comprising: initiating, by multi-level control circuitry, a startup sequence for a multi-level power converter comprising power switch circuitry configurable to route a voltage between a first terminal and a second terminal to selectively charge and/or discharge a first fly capacitor; and selecting, using a circuit electrically couplable to the first terminal to receive a first voltage and the second terminal to receive a second voltage, one or more of the first voltage and the second voltage as a selected voltage to pre-charge the first fly capacitor during the startup sequence.
Aspect 9 includes the method of aspect 8, further comprising operating the multi-level control circuitry in a boost mode during the startup sequence; and drawing available voltage from a battery couplable to the second terminal to supply the second voltage.
Aspect 10 includes the method of any of aspects 8-9, wherein at initiation of the startup sequence, the first fly capacitor is uncharged and/or charged at a voltage level below a ratiometric voltage of the first voltage.
Aspect 11 includes the method of any of aspects 8-10, further comprising: pre-charging the first fly capacitor to a ratiometric voltage of the first voltage during the startup sequence.
Aspect 12 includes the method of any of aspects 8-11, further comprising configuring the multi-level power converter to operate the power switch circuitry as an M-level power converter, for M≥3, by selectively charging and/or discharging a plurality of fly capacitors, each fly capacitor having a corresponding ratiometric voltage of the first voltage; and wherein each of the plurality of fly capacitors is electrically couplable to, and configurable to be pre-charged by, the selected voltage during the startup sequence.
Aspect 13 includes the method of any of aspects 8-12, wherein the circuit is a diode ORing circuit.
Aspect 14 includes the method of any of aspects 8-13, wherein the circuit comprises: a first electrical path comprising a first diode and a first resistor connected in series between the first terminal and an output node of the circuit; and a second electrical path comprising a second diode and a second resistor connected in series between the second terminal and the output node of the circuit.
Aspect 15 includes an integrated circuit comprising: power switch circuitry comprising a plurality of power switches, each of the plurality of power switches having a corresponding boot capacitor, the power switch circuitry configurable to selectively route a voltage between a first terminal and a second terminal; multi-level control circuitry configurable to receive a second voltage at the second terminal and control the power switch circuitry to generate a boosted voltage via one or more fly capacitors at the first terminal; a first path configurable to electrically couple the second voltage to the first terminal; and a circuit electrically couplable to the first terminal to receive a first voltage and the second terminal to receive the second voltage, the circuit configurable to select one or more of the first voltage and the second voltage to pre-charge one or more fly capacitors during a startup sequence; wherein the multi-level control circuitry is further configurable to implement the startup sequence comprising: applying the second voltage to the first terminal; pre-charging a first fly capacitor of the one or more fly capacitors using the selected voltage; and pre-charging a first boot capacitor of a first switch of the plurality of switches using the second voltage.
Aspect 16 includes the integrated circuit of aspect 15, wherein the startup sequence further comprises, after pre-charging the first boot capacitor, operating the multi-level control circuitry as a 2-level boost converter.
Aspect 17 includes the integrated circuit of any of aspects 15-16, wherein the startup sequence further comprises, sequentially transitioning the multi-level control circuitry to operation as an M-level boost converter, where M≥3; and wherein each transition from a current level, N, comprises: pre-charging an N+1-level fly capacitor of the one or more fly capacitors using the selected voltage; pre-charging, for each N+1-level switch, the corresponding boot capacitor; and transitioning to N+1-level boost converter operation when one or more pre-charging thresholds are exceeded.
Aspect 18 includes the integrated circuit of any of aspects 15-17, wherein the circuit comprises: a first electrical path comprising a first diode and a first resistor connected in series between the first terminal and an output node of the circuit; and a second electrical path comprising a second diode and a second resistor connected in series between the second terminal and the output node of the circuit.
Aspect 19 includes the integrated circuit of any of aspects 15-18, wherein the first path comprises a resistor and a diode connected in series.
Aspect 20 includes a system comprising the integrated circuit of any of aspects 15-19, the system comprising: a battery electrically couplable to the second terminal and configurable to generate the second voltage; and wherein, during operation, the multi-level control circuitry is configurable to supply a voltage to a peripheral device electrically couplable to the power switch circuitry.

### General Benefits and Advantages of Multi-Level Power Converters

Embodiments of the current invention improve the power density and/or power efficiency of incorporating circuits and circuit modules or blocks. As a person of ordinary skill in the art should understand, a system architecture is beneficially impacted utilizing embodiments of the current invention in critical ways, including lower power and/or longer battery life. The current invention therefore specifically encompasses system-level embodiments that are creatively enabled by inclusion in a large system design and application.

More particularly, multi-level power converters provide or enable numerous benefits and advantages, including:
adaptability to applications in which input and/or output voltages may have a wide dynamic-range (e.g., varying battery input voltage levels, varying output voltages);
efficiency improvements on the run-time of devices operating on portable electrical energy sources (batteries, generators or fuel cells using liquid or gaseous fuels, solar cells, etc.);
efficiency improvements where efficiency is important for thermal management, particularly to protect other components (e.g., displays, nearby ICs) from excessive heat;
enabling design optimizations for power efficiency, power density, and form-factor of the power converter—for example, smaller-size multi-level power converters may allow placing power converters in close proximity to loads, thus increasing efficiency, and/or to lower an overall bill of materials;
the ability to take advantage of the performance of smaller, low voltage transistors;
adaptability to applications in which power sources can vary widely, such as batteries, other power converters, generators or fuel cells using liquid or gaseous fuels, solar cells, line voltage (AC), and DC voltage sources (e.g., USB, USB-C, power-over Ethernet, etc.);
adaptability to applications in which loads may vary widely, such as ICs in general (including microprocessors and memory ICs), electrical motors and actuators, transducers, sensors, and displays (e.g., LCDs and LEDs of all types);
the ability to be implemented in a number of IC technologies (e.g., MOSFETs, GaN, GaAs, and bulk silicon) and packaging technologies (e.g., flip chips, ball-grid arrays, wafer level scale chip packages, wide-fan out packaging, and embedded packaging).

The advantages and benefits of multi-level power converters enable usage in a wide array of applications. For example, applications of multi-level power converters include portable and mobile computing and/or communication products and components (e.g., notebook computers, ultra-book computers, tablet devices, and cell phones), displays (e.g., LCDs, LEDs), radio-based devices and systems (e.g., cellular systems, WiFi, Bluetooth, Zigbee, Z-Wave, and GPS-based devices), wired network devices and systems, data centers (e.g., for battery-backup systems and/or power conversion for processing systems and/or electronic/optical networking systems), internet-of-things (IOT) devices (e.g., smart switches and lights, safety sensors, and security cameras), household appliances and electronics (e.g., set-top boxes, battery-operated vacuum cleaners, appliances with built-in radio transceivers such as washers, dryers, and refrigerators), AC/DC power converters, electric vehicles of all types (e.g., for drive trains, control systems, and/or infotainment systems), and other devices and systems that utilize portable electricity generating sources and/or require power conversion.

Radio system usage includes wireless RF systems (including base stations, relay stations, and hand-held transceivers) that use various technologies and protocols, including various types of orthogonal frequency-division multiplexing (“OFDM”), quadrature amplitude modulation (“QAM”), Code-Division Multiple Access (“CDMA”), Time-Division Multiple Access (“TDMA”), Wide Band Code Division Multiple Access (“W-CDMA”), Global System for Mobile Communications (“GSM”), Long Term Evolution (“LTE”), 5G, and WiFi (e.g., 802.11a, b, g, ac, ax), as well as other radio communication standards and protocols.

### Programmable Embodiments

Some or all aspects of the invention, particularly the Multi-Level Switch State Selector 1014 of FIG. 10, may be implemented in hardware or software, or a combination of both (e.g., programmable logic arrays). Unless otherwise specified, the algorithms included as part of the invention are not inherently related to any particular computer or other apparatus. In particular, various general purpose computing machines may be used with programs written in accordance with the teachings herein, or it may be more convenient to use a special purpose computer or special-purpose hardware (such as integrated circuits) to perform particular functions. Thus, embodiments of the invention may be implemented in one or more computer programs (i.e., a set of instructions or codes) executing on one or more programmed or programmable computer systems (which may be of various architectures, such as distributed, client/server, or grid) each comprising at least one processor, at least one data storage system (which may include volatile and non-volatile memory and/or storage elements), at least one input device or port, and at least one output device or port. Program instructions or code may be applied to input data to perform the functions described in this disclosure and generate output information. The output information may be applied to one or more output devices in known fashion.

Each such computer program may be implemented in any desired computer language (including machine, assembly, or high-level procedural, logical, or object-oriented programming languages) to communicate with a computer system, and may be implemented in a distributed manner in which different parts of the computation specified by the software are performed by different computers or processors. In any case, the computer language may be a compiled or interpreted language. Computer programs implementing some or all of the invention may form one or more modules of a larger program or system of programs. Some or all of the elements of the computer program can be implemented as data structures stored in a computer readable medium or other organized data conforming to a data model stored in a data repository.

Each such computer program may be stored on or downloaded to (for example, by being encoded in a propagated signal and delivered over a communication medium such as a network) a tangible, non-transitory storage media or device (e.g., solid state memory media or devices, or magnetic or optical media) for a period of time (e.g., the time between refresh periods of a dynamic memory device, such as a dynamic RAM, or semi-permanently or permanently), the storage media or device being readable by a general or special purpose programmable computer or processor for configuring and operating the computer or processor when the storage media or device is read by the computer or processor to perform the procedures described above. The inventive system may also be considered to be implemented as a non-transitory computer-readable storage medium, configured with a computer program, where the storage medium so configured causes a computer or processor to operate in a specific or predefined manner to perform the functions described in this disclosure.

### Fabrication Technologies & Options

In various embodiments of multi-level power converters, it may be beneficial to use specific types of capacitors, particularly for the fly capacitors. For example, it is generally useful for such capacitors to have low equivalent series resistance (ESR), low DC bias degradation, high capacitance, and small volume. Low ESR is especially important for multi-level power converters that incorporate additional switches and fly capacitors to increase the number of voltage levels. Selection of a particular capacitor should be made after consideration of specifications for power level, efficiency, size, etc. Various types of capacitor technologies may be used, including ceramic (including multi-layer ceramic capacitors), electrolytic capacitors, film capacitors (including power film capacitors), and IC-based capacitors. Capacitor dielectrics may vary as needed for particular applications, and may include dielectrics that are paraelectric, such as silicon dioxide (SiO₂), hafnium dioxide (HFO₂), or aluminum oxide Al₂O₃. In addition, multi-level power converter designs may beneficially utilize intrinsic parasitic capacitances (e.g., intrinsic to the power FETs) in conjunction with or in lieu of designed capacitors to reduce circuit size and/or increase circuit performance. Selection of capacitors for multi-level power converters may also take into account such factors as capacitor component variations, reduced effective capacitance with DC bias, and ceramic capacitor temperature coefficients (minimum and maximum temperature operating limits, and capacitance variation with temperature).

Similarly, in various embodiments of multi-level power converters, it may be beneficial to use specific types of inductors. For example, it is generally useful for the inductors to have low DC equivalent resistance, high inductance, and small volume.

The controller(s) used to control startup and operation of a multi-level power converter may be implemented as a microprocessor, a microcontroller, a digital signal processor (DSP), register-transfer level (RTL) circuitry, and/or combinatorial logic.

The term “MOSFET”, as used in this disclosure, includes any field effect transistor (FET) having an insulated gate whose voltage determines the conductivity of the transistor, and encompasses insulated gates having a metal or metal-like, insulator, and/or semiconductor structure. The terms “metal” or “metal-like” include at least one electrically conductive material (such as aluminum, copper, or other metal, or highly doped polysilicon, graphene, or other electrical conductor), “insulator” includes at least one insulating material (such as silicon oxide or other dielectric material), and “semiconductor” includes at least one semiconductor material.

As used in this disclosure, the term “radio frequency” (RF) refers to a rate of oscillation in the range of about 3 kHz to about 300 GHz. This term also includes the frequencies used in wireless communication systems. An RF frequency may be the frequency of an electromagnetic wave or of an alternating voltage or current in a circuit.

With respect to the FIGURES referenced in this disclosure, the dimensions for the various elements are not to scale; some dimensions have been greatly exaggerated vertically and/or horizontally for clarity or emphasis. In addition, references to orientations and directions (e.g., “top”, “bottom”, “above”, “below”, “lateral”, “vertical”, “horizontal”, etc.) are relative to the example drawings, and not necessarily absolute orientations or directions.

Various embodiments of the invention can be implemented to meet a wide variety of specifications. Unless otherwise noted above, selection of suitable component values is a matter of design choice. Various embodiments of the invention may be implemented in any suitable integrated circuit (IC) technology (including but not limited to MOSFET structures), or in hybrid or discrete circuit forms. Integrated circuit embodiments may be fabricated using any suitable substrates and processes, including but not limited to standard bulk silicon, high-resistivity bulk CMOS, silicon-on-insulator (SOI), and silicon-on-sapphire (SOS). Unless otherwise noted above, embodiments of the invention may be implemented in other transistor technologies such as bipolar, BiCMOS, LDMOS, BCD, GaAs HBT, GaN HEMT, GaAs pHEMT, and MESFET technologies. However, embodiments of the invention are particularly useful when fabricated using an SOI or SOS based process, or when fabricated with processes having similar characteristics. Fabrication in CMOS using SOI or SOS processes enables circuits with low power consumption, the ability to withstand high power signals during operation due to FET stacking, good linearity, and high frequency operation (i.e., radio frequencies up to and exceeding 300 GHz). Monolithic IC implementation is particularly useful since parasitic capacitances generally can be kept low (or at a minimum, kept uniform across all units, permitting them to be compensated) by careful design.

Voltage levels may be adjusted, and/or voltage and/or logic signal polarities reversed, depending on a particular specification and/or implementing technology (e.g., NMOS, PMOS, or CMOS, and enhancement mode or depletion mode transistor devices). Component voltage, current, and power handling capabilities may be adapted as needed, for example, by adjusting device sizes, serially “stacking” components (particularly FETs) to withstand greater voltages, and/or using multiple components in parallel to handle greater currents. Additional circuit components may be added to enhance the capabilities of the disclosed circuits and/or to provide additional functionality without significantly altering the functionality of the disclosed circuits.

Circuits and devices in accordance with the present invention may be used alone or in combination with other components, circuits, and devices. Embodiments of the present invention may be fabricated as integrated circuits (ICs), which may be encased in IC packages and/or in modules for ease of handling, manufacture, and/or improved performance. In particular, IC embodiments of this invention are often used in modules in which one or more of such ICs are combined with other circuit blocks (e.g., filters, amplifiers, passive components, and possibly additional ICs) into one package. The ICs and/or modules are then typically combined with other components, often on a printed circuit board, to form part of an end product such as a cellular telephone, laptop computer, or electronic tablet, or to form a higher-level module which may be used in a wide variety of products, such as vehicles, test equipment, medical devices, etc. Through various configurations of modules and assemblies, such ICs typically enable a mode of communication, often wireless communication.

A number of embodiments of the disclosure have been described. It is to be understood that various modifications may be made without departing from the spirit and scope of the disclosure. For example, some of the steps described above may be order independent, and thus can be performed in an order different from that described. Further, some of the steps described above may be optional. Various activities described with respect to the methods identified above can be executed in repetitive, serial, and/or parallel fashion.

It is to be understood that the foregoing description is intended to illustrate and not to limit the scope of the disclosure, which is defined by the scope of the following claims, and that other embodiments are within the scope of the claims. In particular, the scope of the disclosure includes any and all feasible combinations of one or more of the processes, machines, manufactures, or compositions of matter set forth in the claims below. (Note that the parenthetical labels for claim elements are for ease of referring to such elements, and do not in themselves indicate a particular required ordering or enumeration of elements; further, such labels may be reused in dependent claims as references to additional elements without being regarded as starting a conflicting labeling sequence).

What is claimed is:

1. An integrated circuit comprising:
power switch circuitry configurable to selectively route a first voltage between a first terminal and a second terminal, wherein the first terminal is electrically couplable to a supply voltage and the second terminal is electrically couplable to a load;
control circuitry configurable to generate a second voltage from the first voltage by selectively operating the power switch circuitry to charge and/or discharge one or more capacitors;
a disconnect switch configurable to selectively connect and disconnect the supply voltage; and
startup logic configurable to:
open the disconnect switch to disconnect the supply voltage from the first terminal;
operate the power switch circuitry using a startup voltage drawn from the load via the second terminal to generate a third voltage at the first terminal; and
close the disconnect switch to connect the supply voltage to the first terminal when the third voltage is within a predetermined range of the first voltage.

2. The integrated circuit of claim 1, wherein the control circuitry is configurable to operate the power switch circuitry as an M-level power converter, where M≥2, configurable to operate in a charge pump mode, a boost mode, and/or a buck mode to convert the first voltage to the second voltage and/or the second voltage to the first voltage.

3. The integrated circuit of claim 1, wherein the third voltage is greater than the startup voltage; and
wherein the control circuitry is further configured to control the power switch circuitry to operate as a power converter in a boost mode during startup operations to generate the third voltage from the startup voltage.

4. The integrated circuit of claim 1, wherein the startup logic is further configured to sense the first voltage and the third voltage and compare a difference between the first voltage and the third voltage to the predetermined range.

5. The integrated circuit of claim 4, wherein the startup logic comprises interlock circuitry electrically couplable to the supply voltage, the disconnect switch, and the first terminal.

6. The integrated circuit of claim 5, wherein the interlock circuitry comprises:
an amplifier configured to receive the first voltage and the third voltage and output a differential voltage; and
window comparator circuitry configured to determine if the differential voltage is within the predetermined range between a first reference voltage and a second reference voltage.

7. The integrated circuit of claim 1, wherein the startup logic is further configured to generate the third voltage to approximate the first voltage at the first terminal, thereby mitigating inrush and/or backflow currents in the power switch circuitry during startup.

8. The integrated circuit of claim 1, wherein the disconnect switch is couplable between the supply voltage and the first terminal, wherein the disconnect switch is couplable between the first terminal and the power switch circuitry, and/or wherein the power switch circuitry comprises the disconnect switch.

9. The integrated circuit of claim 1, wherein the load is couplable to the second terminal through one or more external switches; and
wherein the startup logic is further configured to operate the one or more external switches and the disconnect switch to mitigate current backflow.

10. A system comprising the integrated circuit of claim 1.

11. A method comprising:
opening a disconnect switch to disconnect a supply voltage from a first terminal of a circuit coupled to power switch circuitry, the power switch circuitry configured to selectively route a first voltage between the first terminal and a second terminal coupled to a load;
operating the power switch circuitry using a startup voltage drawn from the load via the second terminal to generate a third voltage at the first terminal; and
closing the disconnect switch to connect the supply voltage to the first terminal when the third voltage is within a predetermined range of the first voltage.

12. The method of claim 11, further comprising:
operating the power switch circuitry as a multi-level power converter in a charge pump mode, a boost mode, and/or a buck mode to convert the first voltage to a second voltage at the second terminal and/or the second voltage to the first voltage.

13. The method of claim 11, wherein operating the power switch circuitry using the startup voltage further comprises:
operating the power switch circuitry as a multi-level power converter in a boost mode to generate the third voltage from the startup voltage, wherein the third voltage is greater than the startup voltage.

14. The method of claim 11, further comprising:
sensing the first voltage and the third voltage;
comparing a difference between the first voltage and the third voltage to the predetermined range by:
generating a differential voltage between the first voltage and the third voltage using an amplifier; and
determining whether the differential voltage is within the predetermined range using window comparator circuitry configured to determine whether the differential voltage is between a first reference voltage and a second reference voltage.

15. The method of claim 11, further comprising raising the third voltage at the first terminal to approximate the first voltage, thereby mitigating inrush and/or backflow currents after closing the disconnect switch to connect the supply voltage to the first terminal.

16. A system comprising:
a multi-level power converter comprising:
power switch circuitry configurable to selectively route a first voltage between a first terminal and a second terminal, wherein the first terminal is electrically couplable to a supply voltage and the second terminal is electrically couplable to a battery;
control circuitry configurable to selectively operate the power switch circuitry to generate a second voltage from the first voltage by charging and/or discharging one or more capacitors; and
a disconnect switch configurable to selectively connect and disconnect the supply voltage; and
wherein the multi-level power converter further comprises startup logic configurable to:
open the disconnect switch to disconnect the supply voltage from the first terminal;
operate the power switch circuitry using a startup voltage drawn from the battery via the second terminal to generate a third voltage at the first terminal; and
close the disconnect switch to connect the supply voltage to the first terminal when the third voltage is within a predetermined range of the first voltage.

17. The system of claim 16, wherein the third voltage is greater than the startup voltage; and
wherein the startup logic is further configured to operate the multi-level power converter in a boost mode to generate the third voltage from the startup voltage to approximate the first voltage, thereby mitigating inrush and/or backflow currents after closing the disconnect switch to connect the supply voltage to the first terminal.

18. The system of claim 16, wherein the startup logic comprises interlock circuitry couplable to the disconnect switch, the supply voltage, and the first terminal; and
wherein the interlock circuitry is configured to:
sense the first voltage and the third voltage; and
compare a difference between the first voltage and the third voltage to the predetermined range.

19. The system of claim 16, wherein the disconnect switch is couplable between the supply voltage and the first terminal, wherein the disconnect switch is coupled between the first terminal and the power switch circuitry, and/or wherein the power switch circuitry comprises the disconnect switch.

20. The system of claim 19, wherein the system comprises a mobile device comprising the multi-level power converter, the disconnect switch, and the battery;
wherein the supply voltage is a wired and/or wireless supply voltage;
wherein the battery is couplable to the second terminal through one or more external switches; and
wherein the startup logic is further configured to operate the one or more external switches and the disconnect switch to mitigate current backflow.
